(19) United States
(12) Patent Application Publication
(10) Pub. No.: US 2026/0073529 A1
(43) Pub. Date: Mar. 12, 2026

(54) TEMPORALLY SPARSE SCALE ESTIMATION FOR OBJECT TRACKING

(71) Applicant: Snap Inc., Santa Monica, CA (US)

(72) Inventors: Blake Lucas, Culver City, CA (US); Thomas Muttenthaler, Vienna (AT); Thomas Faeulhammer, Vienna (AT)

(21) Appl. No.: 18/883,419

(22) Filed: Sep. 12, 2024

(51) Int. Cl. G06T 7/20; G06T 7/60; G06T 7/70; G06T 7/80; G06T 17/00

(52) U.S. Cl. CPC G06T 7/20; G06T 7/60; G06T 7/70; G06T 7/80; G06T 17/00; G06T 2207/30196

(57) ABSTRACT

Examples in the present disclosure relate to temporally sparse scale estimation for object tracking. A computing device detects a current orientation of an object. The computing device determines that a difference between the current orientation and at least one of a plurality of previously detected orientations of the object is less than a threshold value. Each previously detected orientation has a respective scale estimate. In response to determining that the difference is less than the threshold value, the computing device generates an effective scale estimate for the object based on a combination of the respective scale estimates for the plurality of previously detected orientations. Each respective scale estimate contributes to the effective scale estimate according to a respective difference between the current orientation and the previously detected orientation for the respective scale estimate. The computing device tracks a pose of the object based on the effective scale estimate.

### TECHNICAL FIELD

Subject matter in the present disclosure relates, generally, to object tracking. More specifically, but not exclusively, the subject matter relates to scale estimations that are performed to facilitate object tracking operations of computing devices, such as extended reality (XR) devices.

### BACKGROUND

Some computing devices, such as XR devices, perform object tracking. For example, a tracking system of an XR device processes images captured by the XR device to determine positions of landmarks or other visual features in a scene. The positional data determined by the XR device can be used to facilitate the tracking of an object, such as a hand of a user, within a field of view of the XR device.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 is a block diagram illustrating a network environment for operating an XR device, according to some examples.

FIG. 2 is a block diagram illustrating components of an XR device, according to some examples.

FIG. 3 is a flowchart illustrating a method for scale estimation that is performed to facilitate the tracking of an object by a computing device, according to some examples.

FIG. 4 is a flowchart illustrating a method for generating a new scale estimate and adding the new scale estimate to a time buffer to facilitate the tracking of an object by a computing device, according to some examples.

FIG. 5 diagrammatically illustrates, from the side, three-dimensional (3D) landmarks associated with an object that is captured by a camera of a computing device, wherein the 3D landmarks are estimated based on two-dimensional (2D) landmarks from an image plane of the camera, according to some examples.

FIG. 6 diagrammatically illustrates a kinematic model of a hand, according to some examples.

FIG. 7 diagrammatically illustrates a perspective view of image planes of respective cameras of a computing device that capture images of a hand, wherein 2D landmarks from the image planes are processed to generate a new scale estimate for the hand, according to some examples.

FIG. 8 is a graph illustrating an orientation trajectory of a tracked object, according to some examples.

FIG. 9 is a graph illustrating respective angular distances between a current orientation of an object and various previously detected orientations of the object, wherein respective scale estimates associated with the previously detected orientations are differentially weighted to generate an effective scale estimate associated with the current orientation, according to some examples.

FIG. 10 illustrates a network environment in which a head-wearable apparatus can be implemented, according to some examples.

FIG. 11 is a perspective view of a head-worn device, in accordance with some examples.

FIG. 12 illustrates a further view of the head-worn device of FIG. 11, in accordance with some examples.

FIG. 13 illustrates a 3D user interface generation and utilization process in accordance with some examples.

FIG. 14 illustrates a 3D user interface in accordance with some examples.

FIG. 15 is a block diagram showing a software architecture within which the present disclosure may be implemented, according to some examples.

FIG. 16 is a diagrammatic representation of a machine in the form of a computer system within which a set of instructions may be executed for causing the machine to perform any one or more of the methodologies discussed herein, according to some examples.

### DETAILED DESCRIPTION

The description that follows describes systems, devices, methods, techniques, instruction sequences, or computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Examples in the present disclosure relate to object tracking performed by computing devices. An XR device is an example of a computing device that can perform object tracking. While examples described in the present disclosure focus primarily on XR devices, it will be appreciated that one or more aspects of the present disclosure may also be implemented using other computing devices or computing systems.

XR devices can include augmented reality (AR) devices or virtual reality (VR) devices. “Augmented reality” (AR) can include an interactive experience of a real-world environment where physical objects or environments that reside in the real world are “augmented” or enhanced by computer-generated digital content (also referred to as virtual content or synthetic content). AR can also refer to a system that enables a combination of real and virtual worlds (e.g., mixed reality), real-time interaction, or 3D registration of virtual and real objects. In some examples, a user of an AR system can perceive or interact with virtual content that appears to be overlaid on or attached to a real-world physical object. The term “AR application” is used herein to refer to a computer-operated application that enables an AR experience.

“Virtual reality” (VR) can include a simulation experience of a virtual world environment that is distinct from the real-world environment. Computer-generated digital content is displayed in the virtual world environment. VR can refer to a system that enables a user of a VR system to be completely immersed in the virtual world environment and to interact with virtual objects presented in the virtual world environment. While examples described in the present disclosure focus primarily on XR devices that provide an AR experience, it will be appreciated that one or more aspects of the present disclosure may also be applied to VR.

Perspective ambiguity can arise when a computing device uses a single camera view to track an object. A single camera provides only one 2D projection of a 3D world. This means that there may be multiple possible 3D configurations that could produce the same 2D image. For example, a larger hand farther from a camera could appear similar to a smaller hand closer to the camera. In other words, since certain objects of the same type may have different sizes, it can be challenging for the computing device to determine their position and track them in an accurate manner.

A scale estimate can be generated for an object to facilitate object tracking. The scale estimate can be generated by using image data from multiple views to resolve the aforementioned ambiguity. In some examples, to estimate scale, at least two landmarks on an object are captured from at least two different perspectives.

A “scale estimate,” as used herein, may include a measurement or set of measurements that represent the size of a given object or specific parts of the object. A scale estimate may be derived from stereo camera data through, for instance, a process of 3D triangulation on visible landmarks of the object, where the distances between connected landmarks are measured to determine their respective sizes. For example, a hand scale estimate may include an estimated length of a thumb metacarpal bone, an index finger metacarpal bone, both lengths, or a combination or aggregate measure. A bone length estimate can be referred to as a “representative bone length” since it is used to represent the overall scale of the hand.

In XR experiences, objects may appear well-aligned with the real world if a scale estimate is sensitive to a current viewing direction due to perspective ambiguity (e.g., rendering may be more forgiving to errors in scale if the rendered perspective is close to the camera perspective). In some examples, a scale estimate is averaged over a recent time window to mitigate noise. It may thus be desirable for scale estimation to be sensitive to both the current object pose and time.

In the context of XR devices, since many XR devices use hand gestures as inputs, swift and accurate tracking of a hand is often needed. By using a hand scale estimate, the XR device can more accurately track the hand in its field of view. This enables a user to interact effectively with an XR device without a traditional input device, such as a touchpad or controller.

While scale estimates usually improve the accuracy of object tracking, the generation of new scale estimates can be resource-intensive. For example, in a multi-camera setup, to generate a new scale estimate for an object, a computing device uses at least two cameras to capture the object from different perspectives and applies stereo image triangulation to estimate the positions of 3D landmarks on the hand. Once the 3D landmarks have been estimated, the computing device estimates the distance between certain landmarks to obtain the scale estimate. The processing of the relevant images and related data increases the computational load on the computing device. This technical challenge can be particularly undesirable in devices with limited resources, such as portable (e.g., head-worn and battery-powered) XR devices.

Examples in the present disclosure enable temporally sparse object scale estimation. Techniques are provided for reducing the number of new scale estimates to be generated by a computing device from multiple camera views during a given session, thereby balancing computational load and scale estimation accuracy. For example, where an XR device is tracking a hand, techniques in the present disclosure can reduce the frequency of a process of computing and matching image features correspondences between multiple image views.

In some examples, a computing device maintains and applies a time-windowed, weighted average of past triangulation results to determine an effective scale estimate to use as a current scale estimate in an object tracking process. In some examples, new stereo triangulations are only computed if an object's orientation differs by more than a predetermined measure from all those in the time window. In this way, the computing device can leverage temporal sparsity to minimize or avoid the triggering of full re-estimations of scale if, for example, the object is not rotating, rotating slowly, or appears at a previously observed pose.

In some examples, the available resources of a computing device (e.g., a processor and battery resources of an XR device) are more efficiently utilized by dynamically switching between multi-camera and single-camera modes, and reducing the usage of the multi-camera mode. For example, the computing device avoids using a multi-camera mode for scale estimation when an object's orientation is sufficiently close to one or more others in a time buffer, and instead stays in the single-camera mode for longer by utilizing an effective scale estimate instead of a completely new scale estimate that necessitates the multi-camera mode. This can reduce power consumption and extend the operational time of computing devices, such as XR devices, without significantly compromising on tracking accuracy.

In some examples, a method for facilitating object tracking is performed by a computing device. In some examples, the computing device is an XR device. The tracked object may be a hand, as discussed in examples in the present disclosure. However, it is noted that the method may also be applied to track other types of objects. This may include other articulated, piecewise-rigid objects with visually identifiable landmarks, such as a human arm or a full human body.

The method may include capturing, via one or more cameras of the computing device, at least one image of an object. At least one image is processed to detect a current orientation of the object. For example, the computing device processes the image to obtain 2D landmarks associated with the object. The 2D landmarks are then processed to generate 3D landmarks associated with the object. In some examples, the method includes executing at least one machine learning model to obtain the 2D landmarks from the at least one image and/or executing at least one machine learning model to generate the 3D landmarks based on the 2D landmarks.

The current orientation of the object is detected, for example, based on the 3D landmarks, or by processing the image via a machine learning model. The orientation that is detected by the computing device may be characterized or expressed by various features, parameters, or factors, including, for example: the orientation of a plane fitted to the object, one or more vectors defined by tracked landmarks, a measure of rotation of the object relative to a camera, or a configuration of parts of the object. In the context of hand tracking, for example, the orientation of the hand can be represented by an orientation of the palm of the hand relative to the camera, one or more vectors defined by the hand or its landmarks relative the camera, a plane fitting the one or more vectors, a measure of rotation of the hand relative to the camera, configuration of the fingers (e.g., extended, forming a fist, or an intermediate position), a particular hand gesture, or combinations thereof.

In some examples, the computing device determines a difference between the current orientation and at least one previously detected orientation of a plurality of previously detected orientations of the object. Each previously detected orientation of the plurality of previously detected orientations is associated with a respective scale estimate. In some examples, the respective scale estimate for each previously detected orientation is generated by the computing device in a calibration operation (e.g., in a multi-camera mode).

If the difference is less than a threshold value, the computing device may generate an effective scale estimate for the object based on a combination of the respective scale estimates associated with the plurality of previously detected orientations. In some examples, each respective scale estimate contributes to the effective scale estimate according to a respective difference between the current orientation and the previously detected orientation associated with the respective scale estimate.

In some examples, a pose of the object is tracked based on the effective scale estimate. For example, the 3D landmarks are normalized 3D landmarks, and the tracking of the pose of the object based on the effective scale estimate includes applying the effective scale estimate to the normalized 3D landmarks to obtain the pose of the object.

If the difference meets or exceeds the threshold value for each respective previously detected orientation of the plurality of previously detected orientations, the computing device may trigger commencement of a calibration operation to generate a new scale estimate without utilizing the respective scale estimates associated with the plurality of previously detected orientations. A new scale estimate may include an estimated distance between at least two estimated true locations of two 3D landmarks. The computing device then tracks the pose of the object based on the new scale estimate.

In some examples, the calibration operation is performed in a multi-camera mode that uses images captured by multiple cameras associated with the computing device. In some examples, the tracking of the pose of the object based on the effective scale estimate is performed in a single-camera mode, with the computing device automatically switching from the single-camera mode to the multi-camera mode to perform the calibration operation, and automatically switching from the multi-camera mode back to the single-camera mode after the calibration operation to perform further tracking of the pose of the object based on the new scale estimate in the single-camera mode.

The plurality of previously detected orientations may be temporarily stored (e.g., cached) in a time buffer that is dynamically updated over time. Where a new scale estimate is generated, the new scale estimate is automatically associated with its corresponding orientation, and the time buffer is updated to include the new scale estimate and/or its corresponding orientation.

In some examples, instead of comprising a new estimate based on a new measurement, the effective scale estimate comprises a weighted average of the respective scale estimates associated with the plurality of previously detected orientations. In some examples, a weight of each respective scale estimate within the weighted average is based on a respective angular difference between the current orientation and the previously detected orientation associated with the respective scale estimate. For example, the scale estimate associated with a previously detected orientation that is relatively close to the current orientation has a higher weighting than the scale estimate associated with another previously detected orientation that is farther from the current orientation.

The computing device that performs the method may be, or may include, an XR device. In some examples, the XR device generates virtual content for presentation to a user. The XR device may determine positioning of the virtual content relative to the object based on the tracking of the pose of the object, and cause presentation of the virtual content according to the determined positioning.

Examples described herein provide a practical application that enables a computing device, such as an XR device, to generate accurate data, including depth estimations. This may allow for more accurate object tracking, more accurate positioning of virtual content, improved user experience, or more natural user interactions.

Subject matter in the present disclosure addresses one or more technical problems. As mentioned, the computing device may compute and match image feature correspondences using multiple images. For example, the computing device detects 2D landmarks in images from multiple camera views and finds correspondences between these 2D landmarks and the 3D landmarks of an object model. By reducing the frequency of these computations, the computing device addresses the technical challenge of reducing computational load.

Constant recalculation of scale, even when an object's orientation has not significantly changed, may lead to excessive power consumption and reduced system performance. Examples described herein address technical challenges by using temporally sparse scale estimation. This may include maintaining a time-windowed buffer of scale estimates associated with different object orientations. When generating a current scale estimation, the computing device uses a combination of stored scale estimates, with each estimate contributing according to the difference between the current orientation and the previously detected orientation associated with that estimate. This approach ensures that scale estimation is sensitive to the object's current orientation, providing more accurate results for various poses.

In some examples, the computing device can save power by running a “mono-tracker” (e.g., operating in a single-camera mode) for longer periods during a user session, and only switching to a “multi-tracker” (e.g., operating in the multi-camera mode) when a new scale estimate is to be generated. For example, in the single-camera mode, the computing device relies on a combination of previously generated scale estimates to generate 3D positional coordinates, including depth information, from a single camera's image frames.

The single-camera mode may involve running a tracker on the images from a single camera to obtain 2D positional information, and then using a neural network (which may be referred to as a “lifter” network) to infer the depth of landmarks. In some examples, the depth information is initially obtained as relative information, which can then be transformed to absolute depth information using the scale estimate. In some examples, a lifter component or system takes, as input, a scale estimate (e.g., a reference bone length for a hand) and 2D positional information and processes this data to predict normalized landmarks. In some examples, the normalized landmarks are 3D landmarks expressed relative to the scale estimate, and only need to be multiplied by the hand scale estimate to obtain absolute 3D landmarks.

In the multi-camera mode, input data from two or more cameras of the computing device is utilized. For example, the multi-camera mode is employed during calibration operations after a new object orientation is detected that does not sufficiently correspond to any existing orientations in a buffer component. In the multi-camera mode, the computing device can utilize stereo vision principles to reconstruct 3D positions of landmarks and generate new scale estimates.

It is noted that a “single-camera mode,” as used herein, may refer to using a single camera's image frame(s) for a particular point in time or period of time. However, in some examples, the computing device may switch between different cameras over time while still being in the “single-camera mode.” For example, images from a first camera captured in a first period are selected for processing at a first stage, while images from a second camera captured in a second period are selected for processing at a second stage following the first stage. In this way, the computing device remains in the “single-camera mode” but can benefit from camera views of different cameras at different points in time. On the other hand, when in the “multi-camera mode,” the computing device may select and process images from multiple cameras captured simultaneously to benefit, for example, from stereo vision principles.

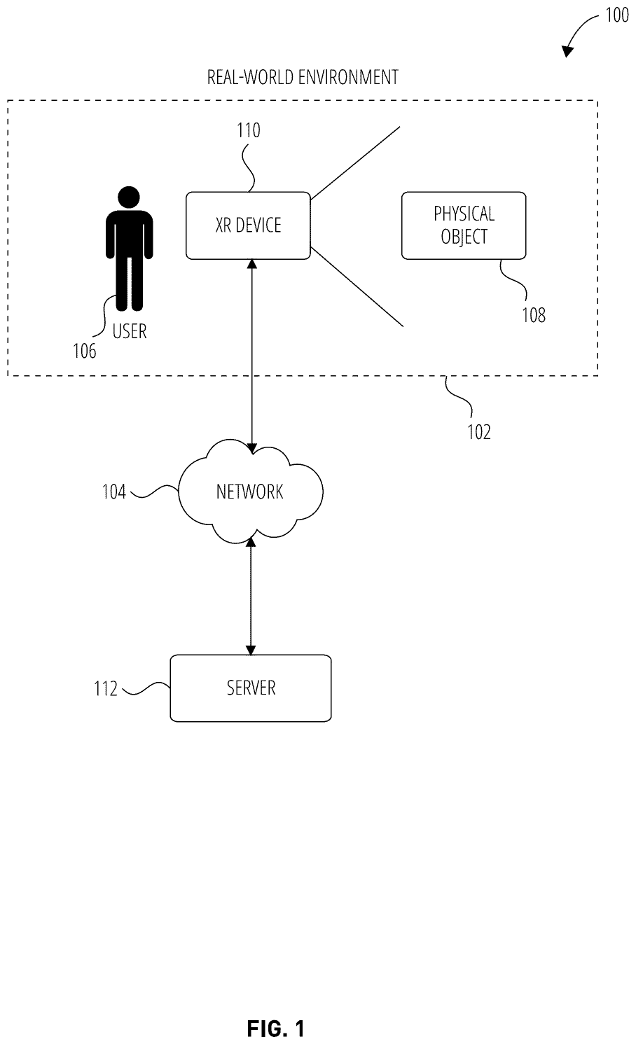

FIG. 1 is a network diagram illustrating a network environment 100 suitable for operating an XR device 110, according to some examples. The network environment 100 includes an XR device 110 and a server 112, communicatively coupled to each other via a network 104. The server 112 may be part of a network-based system. For example, the network-based system may be or include a cloud-based server system that provides additional information, such as virtual content (e.g., 3D models of virtual objects, or augmentations to be applied as virtual overlays onto images depicting real-world scenes) to the XR device 110.

A user 106 operates the XR device 110. The user 106 may be a human user (e.g., a human being), a machine user (e.g., a computer configured by a software program to interact with the XR device 110), or any suitable combination thereof (e.g., a human assisted by a machine or a machine supervised by a human). The user 106 is not part of the network environment 100, but is associated with the XR device 110. For example, where the XR device 110 is a head-wearable apparatus, the user 106 wears the XR device 110 during a user session.

The XR device 110 may have different display arrangements. In some examples, the display arrangement may include a screen that displays what is captured with a camera of the XR device 110. In some examples, the display of the device may be transparent or semi-transparent. In some examples, the display may be non-transparent and wearable by the user to cover the field of vision of the user.

The user 106 operates an application of the XR device 110, referred to herein as an AR application. The AR application may be configured to provide the user 106 with an experience triggered or enhanced by a physical object 108, such as a 2D physical object (e.g., a picture), a 3D physical object (e.g., a statue), a location (e.g., at factory), or any references (e.g., perceived corners of walls or furniture, or Quick Response (QR) codes) in the real-world physical environment. For example, the user 106 may point a camera of the XR device 110 to capture an image of the physical object 108 and a virtual overlay may be presented over the physical object 108 via the display.

Experiences may also be triggered or enhanced by a hand or other body part of the user 106. For example, the XR device 110 detects and responds to hand gestures. The XR device 110 may also present information content or control items, such as user interface elements, to the user 106 during a user session.

The XR device 110 includes one or more tracking systems or tracking components (not shown in FIG. 1). The tracking components track the pose (e.g., position and orientation) of the XR device 110 relative to a real-world environment 102 using image sensors (e.g., depth-enabled 3D camera, or image camera), inertial sensors (e.g., gyroscope, accelerometer, or the like), wireless sensors (e.g., Bluetooth™ or Wi-Fi™), a Global Positioning System (GPS) sensor, and/or audio sensor to determine the location of the XR device 110 within the real-world environment 102. The tracking components can also track the pose of real-world objects, such as the physical object 108 or the hand of the user 106. In some examples, the XR device 110 generates scale estimates to facilitate or improve the tracking of such objects.

In some examples, the server 112 is used to detect and identify the physical object 108 based on sensor data (e.g., image and depth data) from the XR device 110, and determine a pose of the XR device 110 and the physical object 108 based on the sensor data. The server 112 can also generate a virtual object or other virtual content based, for example, on the pose of the XR device 110 and the physical object 108.

In some examples, the server 112 communicates virtual content to the XR device 110. In other examples, the XR device 110 obtains virtual content through local retrieval or generation. The XR device 110 or the server 112, or both, can perform image processing, object detection, and object tracking functions based on images captured by the XR device 110 and one or more parameters internal or external to the XR device 110.

The object recognition, tracking, and AR rendering can be performed on either the XR device 110, the server 112, or a combination between the XR device 110 and the server 112. Accordingly, while certain functions are described herein as being performed by either an XR device or a server, the location of certain functionality may be a design choice. For example, it may be technically preferable to deploy particular technology and functionality within a server system initially, but later to migrate this technology and functionality to a client installed locally at the XR device where the XR device has sufficient processing capacity.

The network 104 may be any network that enables communication between or among machines (e.g., server 112), databases, and devices (e.g., XR device 110). Accordingly, the network 104 may be a wired network, a wireless network (e.g., a mobile or cellular network), or any suitable combination thereof. The network 104 may include one or more portions that constitute a private network, a public network (e.g., the Internet), or any suitable combination thereof.

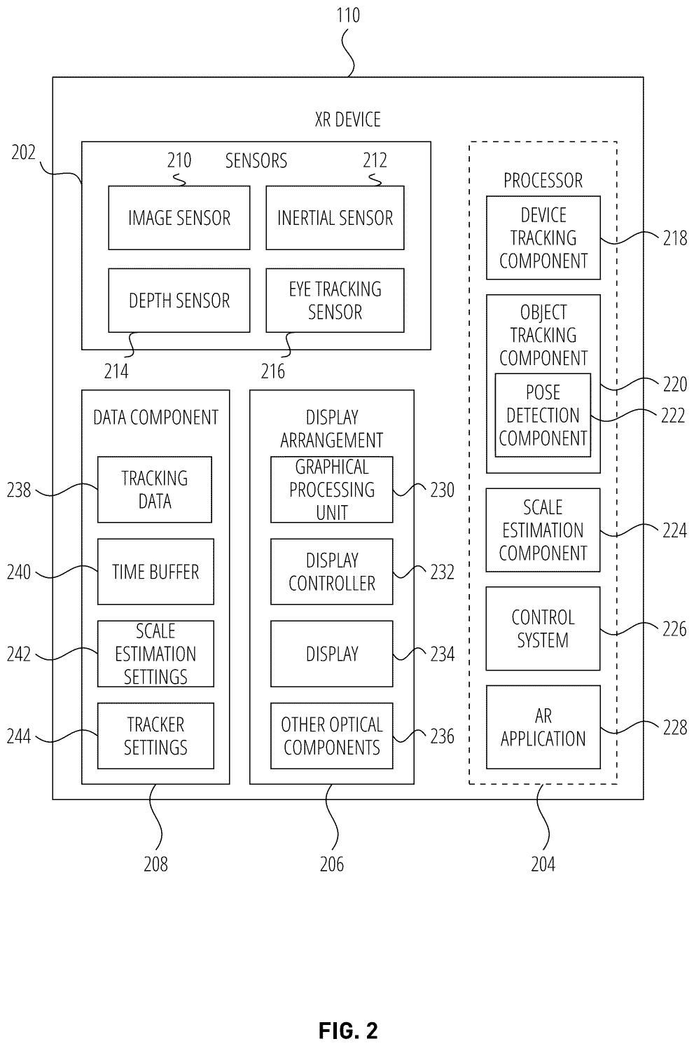

FIG. 2 is a block diagram illustrating components (e.g., modules, parts, systems, or subsystems) of the XR device 110, according to some examples. The XR device 110 is shown to include sensors 202, a processor 204, a display arrangement 206, and a data component 208. It will be appreciated that FIG. 2 is not intended to provide an exhaustive indication of components of the XR device 110.

The sensors 202 include one or more image sensors 210, one or more inertial sensors 212, one or more depth sensors 214, and one or more eye tracking sensors 216. The image sensor 210 includes one or more of a color camera, a thermal camera, or a grayscale, global shutter tracking camera. The image sensor 210 may include more than one of the same cameras (e.g., multiple color cameras). In some examples, the XR device 110 includes at least two cameras to capture images of an object from at least two camera views, thereby enabling the XR device 110 to perform triangulation to generate 3D position information related to the object.

The inertial sensor 212 includes, for example, a combination of a gyroscope, accelerometer, and a magnetometer. In some examples, the inertial sensor 212 includes one or more Inertial Measurement Units (IMUs). An IMU enables tracking of movement of a body by integrating the acceleration and the angular velocity measured by the IMU. An IMU may include a combination of accelerometers and gyroscopes that can determine and quantify linear acceleration and angular velocity, respectively. The values obtained from the gyroscopes of the IMU can be processed to obtain the pitch, roll, and heading of the IMU and, therefore, of the body with which the IMU is associated. Signals from the accelerometers of the IMU also can be processed to obtain velocity and displacement. In some examples, the magnetic field is measured by the magnetometer to provide a reference for orientation, helping to correct any drift in the gyroscope and/or accelerometer measurements, thereby improving the overall accuracy and stability of the estimations.

The depth sensor 214 may include one or more of a structured-light sensor, a time-of-flight sensor, a passive stereo sensor, and an ultrasound device. The eye tracking sensor 216 is configured to monitor the gaze direction of the user, providing data for various applications, such as adjusting the focus of displayed content or determining a zone of interest in the field of view. The XR device 110 may include one or multiple eye tracking sensors 216, such as infrared eye tracking sensors, corneal reflection tracking sensors, or video-based eye-tracking sensors.

Other examples of sensors 202 include a proximity or location sensor (e.g., near field communication, GPS, Bluetooth™, Wi-Fi™), an audio sensor (e.g., a microphone), or any suitable combination thereof. It is noted that the sensors 202 described herein are for illustration purposes and the sensors 202 are thus not limited to the ones described above.

The processor 204 implements or causes execution of a device tracking component 218, an object tracking component 220, a scale estimation component 224, a control system 226, and an AR application 228. The object tracking component 220 includes a pose detection component 222.

The device tracking component 218 estimates a pose of the XR device 110. For example, the device tracking component 218 uses data from the image sensor 210 and the inertial sensor 212 to track the pose of the XR device 110 relative to a frame of reference (e.g., real-world environment 102). In some examples, the device tracking component 218 uses tracking data to determine the 3D pose of the XR device 110. The 3D pose is a determined position of the XR device 110 in relation to the user's real-world environment 102. The pose may further include the orientation of the XR device 110 in relation to the real-world environment 102 (e.g., providing the pose in six degrees of freedom (6DOF)). The device tracking component 218 continually gathers and uses updated sensor data describing movements of the XR device 110 to determine updated poses of the XR device 110 that indicate changes in the relative position and/or orientation of the XR device 110 from the physical objects in the real-world environment 102.

A “SLAM” (Simultaneous Localization and Mapping) system, “VIO” (Visual-Inertial Odometry) system, or other similar system may be used in the device tracking component 218. A SLAM system may be used to understand and map a physical environment in real-time. This allows, for example, an XR device to accurately place digital objects in the real world and track their position as a user moves and/or as objects move. A VIO system combines data from an IMU and a camera to estimate the position and orientation of an object in real-time. The VIO system does not necessarily build a map, but uses visual features and inertial data to estimate motion relative to an initial pose.

The object tracking component 220 enables the detection and tracking of an object, such as the physical object 108 of FIG. 1 or a hand of a user. The object tracking component 220 may include a computer-operated application or system that enables a device or system to track visual features identified in images captured by the one or more image sensors 210, such as one or more cameras. In some examples, the object tracking component 220 builds a model of a real-world environment based on the tracked visual features. An object tracking component 220 may implement one or more object tracking machine learning models to detect and/or track an object in the field of view of a user during a user session.

An object tracking machine learning model may comprise a neural network trained on suitable training data to identify and/or track objects in a sequence of frames captured by the XR device 110. An object tracking machine learning model typically uses an object's appearance, motion, landmarks, and/or other features to estimate location in subsequent frames.

In some examples, the object tracking component 220 implements a landmark detection system (e.g., using a landmark detection machine learning model). In some examples, based on images captured using stereo cameras of the image sensors 210, the object tracking component 220 identifies 3D landmarks associated with joints of a hand of the user 106.

The object tracking component 220 can thus detect and track the 3D positions of various joints (or other landmarks, such as bones or other segments of the hand) on the hand as the hand moves in the field of view of the XR device 110. In some examples, positions and orientations (e.g., relative angles) of the landmarks are tracked.

In some examples, the object tracking component 220 is calibrated for a specific set of features. For example, when the object tracking component 220 performs hand tracking, a calibration component calibrates the object tracking component 220 by using a hand calibration, such as a hand scale estimate for a particular user of the XR device 110. The calibration component can perform one or more calibration steps to measure or estimate hand features, such as the size of a hand and/or details of hand landmarks (e.g., fingers and joints). This may include bone length calibrations.

As mentioned, the object tracking component 220 of FIG. 2 includes a pose detection component 222. The pose detection component 222 is configured to detect object poses, including hand poses of a user relative to the XR device 110. In some examples, the pose detection component 222 detects the pose of a tracked object and tracks changes in the pose over time. A “pose,” as used in the present disclosure, may include one more of the orientation, configuration, or spatial arrangement of an object (e.g., relative to one or more cameras or other sensors of an XR device). Where the object is a hand, the pose may include the orientation, configuration, or spatial arrangement of the hand or part thereof, such as the palm, a finger, a thumb, or combinations thereof. A pose may include a position associated with the object. For example, a pose may include a translation and rotation of the hand, or part thereof, in 3D space relative to the XR device (e.g., the camera of the XR device).

The pose detection component 222 may generate data representing detected poses, such as one or more vectors representing the detected pose, or a plane formed by the vectors. Such data may be temporarily cached (e.g., as part of the time buffer 240 referred to below). In some examples, the pose detection component 222 identifies a pose based on a gesture performed by the hand.

In some examples, the pose detection component 222 analyzes spatial relationships between landmarks such as finger joints, knuckles, or the wrist to determine the pose. The pose detection component 222 can detect changes in hand pose over time, allowing for dynamic tracking of hand movements and gestures. In some examples, the pose detection component 222 compares a detected hand pose to a set of previously detected hand poses to determine the differences between the detected hand pose and the previously detected hand poses (e.g., angular differences).

The scale estimation component 224 is responsible for generating and managing object scale estimates. In some examples, the scale estimation component 224 generates a scale estimate using a predetermined metric (e.g., computation of a particular bone length from the landmarks detected while the hand assumed a particular pose).

In some examples, when a new object pose is detected by the pose detection component 222, the scale estimation component 224 determines whether the new pose is sufficiently similar to any previously detected pose of that object for which a scale estimate exists (e.g., that is temporarily stored in the data component 208). If not, the scale estimation component 224 triggers a calibration operation to obtain a new scale estimate. If the new pose is sufficiently similar, an effective scale estimate is calculated for the new pose based on one or more existing scale estimates, thereby obviating the need for the calibration operation.

The control system 226 may control various operations of the XR device 110. In some examples, the control system 226 manages switching between multi-camera and single-camera modes for hand tracking and scale estimation. For instance, the control system 226 initiates the multi-camera mode for calibration operations and switches to the single-camera mode for regular tracking (e.g., based on a known or selected scale estimate) to conserve power.

The AR application 228 performs various operations to provide an AR experience to the user. For example, the AR application 228 retrieves a virtual object (e.g., 3D object model) based on an identified physical object 108 or physical environment (or other real-world feature), or retrieves a digital effect to apply to the physical object 108. A graphical processing unit 230 of the display arrangement 206 causes display of the virtual object, digital effect, or the like. In some examples, the AR application 228 includes a local rendering engine that generates a visualization of a virtual object overlaid (e.g., superimposed upon, or otherwise displayed in tandem with) on an image of the physical object 108 (or other real-world feature) captured by the image sensor 210. A visualization of the virtual object may be manipulated by adjusting a position of the physical object or feature (e.g., its physical location, orientation, or both) relative to the image sensor 210. Similarly, the visualization of the virtual object may be manipulated by adjusting a pose of the XR device 110 relative to the physical object or feature.

The graphical processing unit 230 may include a render engine that is configured to render a frame of a 3D model of a virtual object based on the virtual content provided by the AR application 228 and the pose of the XR device 110 (and, in some cases, the position of a tracked object). In other words, the graphical processing unit 230 uses the pose of the XR device 110 to generate frames of virtual content to be presented on a display 234. For example, the graphical processing unit 230 communicates with the AR application 228 to apply the pose to render a frame of the virtual content such that the virtual content is presented at an orientation and position in the display 234 to properly augment the user's reality. As an example, the graphical processing unit 230 may use the pose data to render a frame of virtual content such that, when presented on the display 234, the virtual content is caused to be presented to a user so as to overlap with a physical object in the user's real-world environment 102.

In some examples, the AR application 228 can work with the graphical processing unit 230 to generate updated frames of virtual content based on updated poses of the XR device 110 and updated tracking data generated by the abovementioned tracking components, which reflect changes in the position and orientation of the user in relation to physical objects in the user's real-world environment 102, thereby resulting in a more immersive experience.

In some examples, the graphical processing unit 230 transfers the rendered frame to a display controller 232. The display controller 232 is positioned as an intermediary between the graphical processing unit 230 and the display 234, receives the image data (e.g., rendered frame) from the graphical processing unit 230, re-projects the frame (by performing a warping process) based on a latest pose of the XR device 110 (and, in some cases, object tracking pose forecasts or predictions), and provides the re-projected frame to the display 234.

In some examples, the display 234 is not directly in the gaze path of the user. For example, the display 234 can be offset from the gaze path of the user and other optical components 236 direct light from the display 234 into the gaze path. The other optical components 236 include, for example, one or more mirrors, one or more lenses, or one or more beam splitters.

It will be appreciated that, in examples where an XR device includes multiple displays, each display can have a dedicated graphical processing unit and/or display controller. It will further be appreciated that where an XR device includes multiple displays, such as in the case of AR glasses or any other AR device that provides binocular vision to mimic the way humans naturally perceive the world, a left eye display arrangement and a right eye display arrangement can deliver separate images or video streams to each eye. Where an XR device includes multiple displays, steps may be carried out separately and substantially in parallel for each display, in some examples, and pairs of features or components may be included to cater for both eyes.

For example, an XR device captures separate images for a left eye display and a right eye display (or for a set of right eye displays and a set of left eye displays), and renders separate outputs for each eye to create a more immersive experience and to adjust the focus and convergence of the overall view of a user for a more natural, 3D view. Thus, while a single set of display arrangement components is shown in FIG. 2, similar techniques may be applied to cover both eyes by providing a further set of display arrangement components.

Still referring to FIG. 2, the data component 208 can be used to store various data, such as tracking data 238, data for temporary storage in a time buffer 240, scale estimation settings 242, and/or tracker settings 244. User-related data is only stored after approval has been obtained from the user. Furthermore, the tracking data 238 and the time buffer 240 are only temporarily stored (e.g., cached for a particular user session or part thereof) and not persisted to other storage.

The tracking data 238 may include data obtained from one or more of the sensors 202, such as image data from the image sensor 210, eye tracking data from the eye tracking sensor 216, depth maps generated by the XR device 110 or the like. The tracking data 238 can also include data related to the position, velocity, and/or acceleration of a user's hand movements or the movements of another tracked object.

In some examples, the tracking data 238 includes “raw” data obtained from the sensors, and the “raw” data is processed by the object tracking component 220 to determine further data, such as landmark data. The landmark data can be further processed by the object tracking component 220 to generate further data, such as pose data that is also stored as part of the tracking data 238.

The time buffer 240 temporarily stores scale estimations and/or object pose data. For example, the time buffer 240 stores a finite history of scale estimates along with their corresponding object poses (e.g., detected orientations). In some examples, the time buffer 240 is dynamically updated over time, maintaining a predetermined time window (e.g., 2 minutes, 3 minutes, 5 minutes, 10 minutes, or 30 minutes) of scale estimates that can be used for interpolation or weighted averaging of scale estimates for current object orientations.

In some examples, the time buffer 240 allows the XR device 110 to use past scale estimates for generating effective scale estimates, reducing the number of times the XR device 110 recalculates scale using more computationally expensive methods (e.g., multi-camera mode scale estimations). The time buffer 240 may be configured to maintain a predetermined maximum number of samples. For example, the time buffer 240 can be considered “graceful” in the sense that it continuously shifts to include the most recent scale estimates while removing older ones, thereby allowing for smooth and efficient updating.

The scale estimation settings 242 may include configuration parameters used by the XR device 110 to determine when and how to perform scale estimations. This may include thresholds for triggering new scale estimations and parameters for a weighting function used in combining scale estimates. In the context of hand scale estimates, the scale estimation settings 242 can include rules for measuring a bone length for a certain part of the hand, rules for determining whether a hand-related measurement is viable, or rules for determining when a new bone length estimate has sufficiently “stabilized” or “converged.”

The tracker settings 244 include configuration parameters for the tracking of objects. The tracker settings 244 may include details of hand detectors and/or hand trackers (e.g., machine learning model details) to enable detection and/or tracking. The tracker settings 244 can further specify parameters for switching between multi-camera and single-camera modes.

One or more of the components described herein may be implemented using hardware (e.g., a processor of a machine) or a combination of hardware and software. For example, a component described herein may configure a processor to perform the operations described herein for that component. Moreover, two or more of these components may be combined into a single component, and the functions described herein for a single component may be subdivided among multiple components. Furthermore, according to various examples, components described herein as being implemented within a single machine, database, component, or device may be distributed across multiple machines, databases, components, or devices.

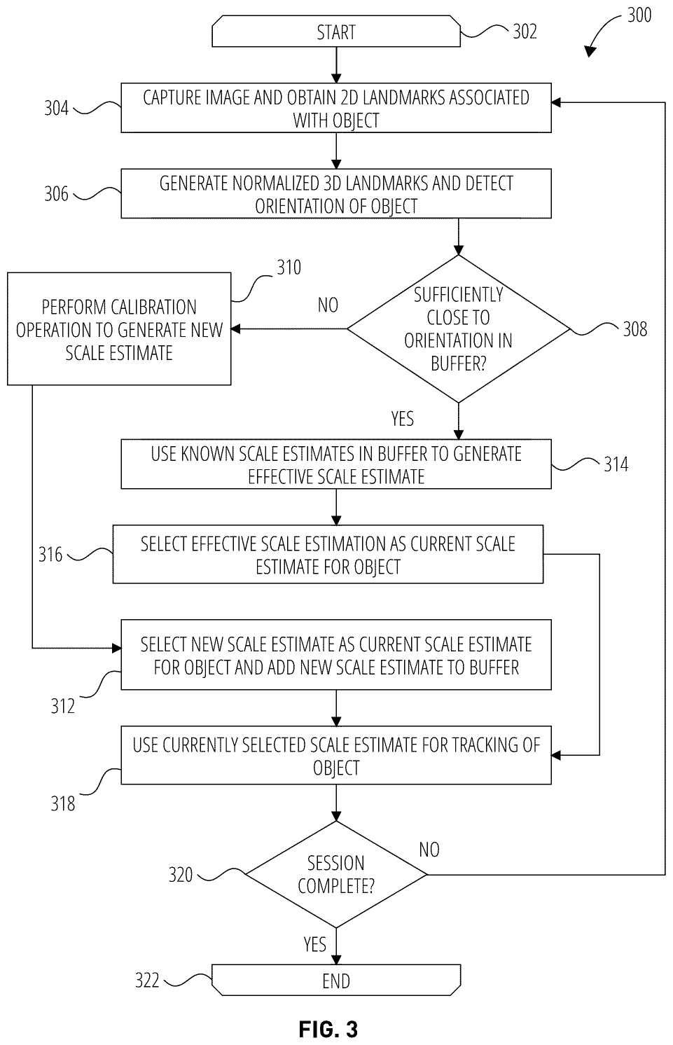

FIG. 3 is a flowchart illustrating a method 300 for scale estimation that is performed to facilitate the tracking of an object by a computing device, according to some examples. By way of example and not limitation, aspects of the method 300 may be performed by components, devices, systems, or networks shown in FIG. 1 and FIG. 2, and they may be referenced below. Accordingly, the XR device 110 is referenced as a non-limiting example of the computing device to describe operations of the method 300.

The method 300 commences at opening loop operation 302. For example, the XR device 110 starts a new user session. A “user session” is used herein to refer to an operation of an application during periods of time. For example, where the XR device 110 is a head-wearable device, a user session refers to an operation of the AR application executing on the XR device 110 between the time the user puts on the XR device and the time the user takes off the head-wearable device. In some examples, the user session starts when the XR device is turned on or is woken up from sleep mode and stops when the XR device is turned off or placed in sleep mode. In another example, the user session starts when the user runs or starts the AR application, or runs or starts a particular feature of the AR application, and stops when the user ends the AR application or stops the particular features of the AR application.

During the user session, the XR device 110 tracks an object. For example, in the context of AR, the XR device 110 tracks one or more objects in the field of view to receive user inputs, generate and present virtual content as overlaid onto the real world, and update the virtual content in real-time to ensure that it remains well-aligned with real-world objects. The tracking process includes detecting different poses (e.g., orientations) of the object.

A hand is used as a non-limiting example of an object to describe certain operations of the method 300. The hand may be a hand of the user 106 of the XR device 110.

The method 300 proceeds to operation 304, where the XR device 110 captures an image of the object (e.g., the hand) and obtains 2D landmarks associated with the object. For example, the XR device 110 uses one or more machine learning models to extract 2D landmarks from a single camera image while operating in the single-camera mode.

At operation 306, the XR device 110 detects an orientation of the object. In some examples, the XR device 110 generates normalized 3D landmarks based on the 2D landmarks from operation 304. For example, a lifter network is executed by the XR device 110 to “lift” the 2D landmarks into 3D space, with the 3D landmarks being reported in normalized space (since scale is ambiguous from a single camera view). The orientation of the object can then be detected or estimated based on the 3D landmarks.

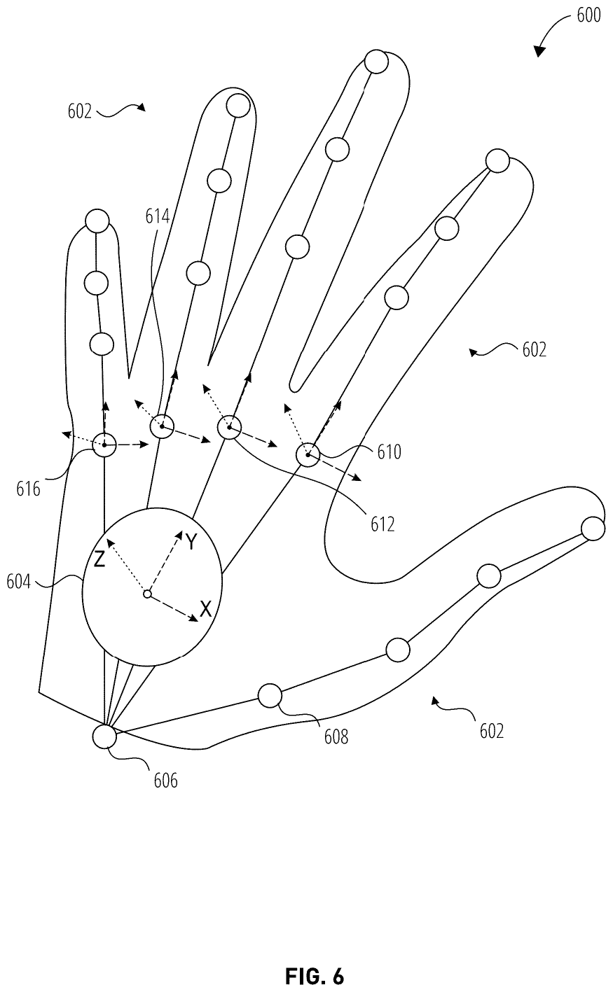

For instance, in the context of hand tracking, the object tracking component 220 operates as follows to detect a current orientation of the object (e.g., a current orientation at a particular point in time):
A first machine learning model (e.g., as part of a 2D tracker component) is executed by the object tracking component 220 to detect and extract 2D landmarks from the image. This provides the estimated 2D (e.g., (x, y)) positions of the landmarks on the hand relative to the camera (e.g., in camera space).
The 2D landmarks are “lifted” into 3D space by the object tracking component 220 using a second machine learning model. The 3D landmarks may be reported in a normalized camera space since scale may be ambiguous from a single camera view. For example, the second machine learning model is trained to process 2D landmark positions and generate normalized 3D position data based on a kinematic model of the hand.
The pose of the hand is detected by the pose detection component 222 based on the (normalized) 3D landmarks to provide the “current orientation.” For example, the pose detection component 222 analyzes the relative positions of landmarks at the base of each finger of the hand, together with a wrist landmark, to determine the pose of the palm of the hand, which is deemed to represent the pose of the hand. For example, a plane best fitting these landmarks is selected to represent the hand pose, as is discussed with reference to FIG. 6.

The orientation of an object can thus be mathematically represented using one or more vectors, with the aforementioned technique being a non-limiting example. In other examples, the XR device 110 does not use 3D landmarks to detect the current orientation of the object and instead processes the image data captured at operation 304 using a trained machine learning model that predicts the orientation directly from the image data. For example, the machine learning model is trained in a supervised learning process, with training data of objects including orientation or pose labels, to predict the orientation of a new object given an image depicting its pose. In various examples, the current orientation includes one or more angular values that represent the estimated orientation of the object (e.g., relative to the XR device 110).

At decision operation 308, the XR device 110 checks whether the current orientation of the object is sufficiently close to at least one orientation in the time buffer 240 that was previously detected during the user session, and for which the time buffer 240 already stores a scale estimate, as generated by the XR device 110. Decision operation 308 is automatically performed to determine whether to launch a new scale calibration process.

If the XR device 110 determines that the current orientation is not sufficiently close to any of the previously detected orientations in the time buffer 240 (e.g., not within a predetermined angular range or threshold), the method 300 proceeds to operation 310 where the XR device 110 performs a calibration operation to generate a new scale estimate for the current orientation of the object.

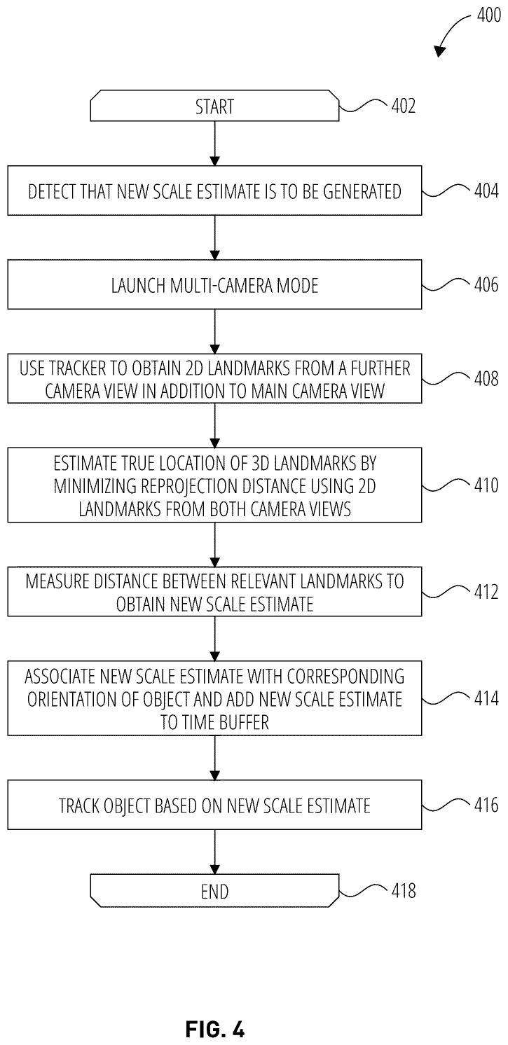

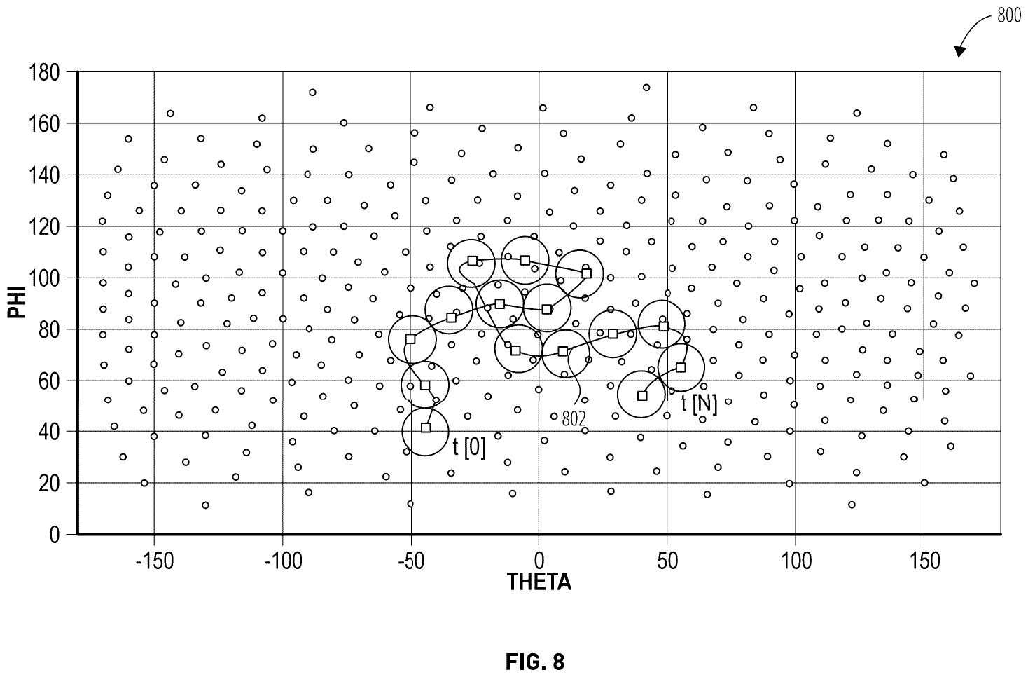

In some examples, the XR device 110 switches to the multi-camera mode to generate the new scale estimate. Example techniques for generating a new scale estimate are described with reference to FIG. 4, and examples of angular distance thresholds that can be applied to determine whether to generate a new scale estimate are discussed with reference to FIG. 8.

At operation 312, the XR device 110 selects the newly generated scale estimate as the current scale estimate to be used for the tracking of the object. Furthermore, the XR device 110 adds the newly generated scale estimate, together with its associated orientation to the time buffer 240. In this way, the newly generated scale estimate can be used, at a future point in time, to generate an effective scale estimate, as discussed below.

On the other hand, if the XR device 110 determines that the current orientation is sufficiently close to at least one of the previously detected orientations in the time buffer 240 (e.g., within a predetermined angular range or threshold), the method 300 proceeds from decision operation 308 to operation 314, where the XR device 110 uses the known scale estimates associated with the previously detected orientations in the time buffer 240 to generate an effective scale estimate for the current orientation of the object. In other words, the XR device 110 does not trigger a calibration operation. Instead of generating a “new” scale estimate, the XR device 110 calculates an “effective” scale estimate based on a combination of already-generated scale estimates related to the particular object.

In some examples, the effective scale estimate is generated as follows by the scale estimation component 224:
The current orientation of the object (e.g., the hand) is used as input. The current orientation can be expressed using one or more angular values.
The scale estimation component 224 determines the existing scale estimates in the time window (e.g., the time buffer 240) by angular distance from the current orientation.
The scale estimation component 224 calculates a weighted average of the scale estimates in the time window, inversely proportional to the angular distance from the current orientation. For example, the scale estimation component 224 applies exponential fall-off as a function of angular distance, or another monotonically decreasing weighting function. This ensures that the XR device 110 favors certain results or samples based on orientation locality (e.g., the scale estimates of closer orientations contribute more to the effective scale estimate).
The weighted average is output by the scale estimation component 224 as the effective scale estimate for the current orientation.

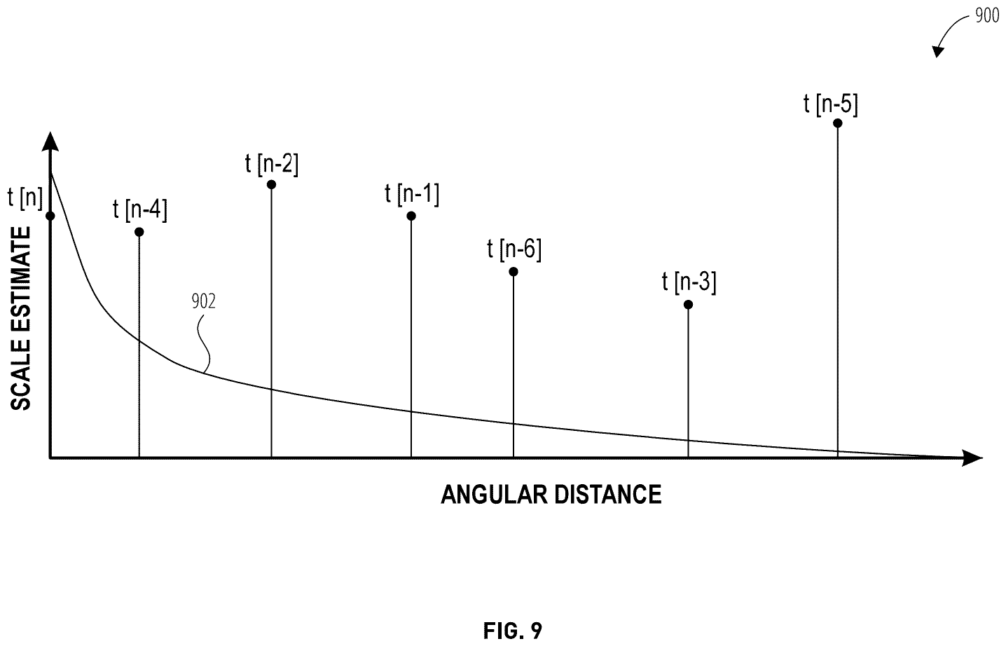

A non-limiting example illustrating how scale estimates in a time window are ordered by angular distance from the current orientation, as well as how each sample can be relatively weighted using a weight function, is discussed with reference to FIG. 9.

Referring again to FIG. 3, after generating the effective scale estimate, the XR device 110 selects the effective scale estimate as the current scale estimate for tracking the object (at operation 316). In some examples, since the effective scale estimate is not a newly generated scale estimate (e.g., a new estimate generated using multi-camera mode) but rather a combination of previous scale estimates, the effective scale estimate is not added to the time buffer 240. Accordingly, in some examples, the effective scale estimates are not added to the time buffer 240, and only new scale estimates that are generated using calibration operations are added to the time buffer 240.

At operation 318, the XR device 110 proceeds to use the currently selected scale estimate for the tracking of the object. In some examples, irrespective of whether a calibration operation was performed with respect to the orientation detected at operation 306, at operation 318, the XR device 110 uses the currently selected scale estimate to track the object in the single-camera mode.

The scale estimate allows the XR device 110 to obtain positional information for the object, including one or more depth estimations relative to a camera. This enables the XR device 110 to track the object (e.g., the hand of the user 106) using the positional data. In periods when operation 310 is not performed, the XR device 110 can track the object without having to switch from the single-camera mode to the multi-camera mode, because the previous scale estimates facilitate tracking from a single camera stream. In this way, the XR device 110 can “fall back on” previously generated scale estimates until a “new” orientation (e.g., a pose that is significantly different from those for which scale estimates are already available) is detected.

The positional data may be applied to determine where to position virtual content. For example, where the XR device 110 tracks the hand of a wearer the XR device 110, the XR device 110 determines where to display a virtual apple such that it will appear to be in the palm of the hand in a realistic or immersive manner. The object tracking component 220 can input positional data for a number of image frames into a machine learning model that is trained to predict a future position of the hand. This allows the XR device 110 to align the virtual content with the predicted future position of the hand. The XR device 110 then renders the virtual content and causes presentation thereof using, for example, the display arrangement 206.

At decision operation 320 the XR device 110 checks whether the user session has been ended (e.g., the AR application 228 has been closed). If the user session has ended, the method 300 concludes at closing loop operation 322. If the user session has not ended, the XR device 110 continues to process images of the object to check the object's orientation and perform operations as discussed above. It is noted that the relevant orientations and their corresponding scale estimates are not stored in a persistent manner. Instead, they are temporarily cached in the data component 208 during the user session to allow the XR device 110 to reuse previously generated scale estimates, and are removed from memory at the end of the user session.

FIG. 4 is a flowchart illustrating a method 400 for generating a new scale estimate and adding the new scale estimate to a time buffer to facilitate the tracking of an object by a computing device, according to some examples. By way of example and not limitation, aspects of the method 400 may be performed by components, devices, systems, or networks shown in FIG. 1 and FIG. 2, and they may be referenced below. Accordingly, the XR device 110 is referenced as a non-limiting example of the computing device to describe operations of the method 400.

The operations of the method 400 of FIG. 4 are described with reference to an example XR device 110 that includes two cameras (e.g., two of the image sensors 210) that capture objects from different perspectives, enabling it to capture and process stereo image data. However, it will be appreciated that, in other examples, an XR device can include more than two cameras (e.g., four cameras). Furthermore, in the operations of the method 400 of FIG. 4, the scale estimate includes a single bone length estimate, such as a bone length estimate for a bone in a hand (e.g., an estimate of the length of the index finger metacarpal bone), to represent the overall scale of the object. However, it will be appreciated that other types or combinations of scale estimates can be generated using techniques similar to those of FIG. 4. For example, a scale estimate can consist of an average of multiple bone lengths, or can be defined by a set of multiple bone lengths (e.g., a bone length for the index finger metacarpal bone as well as a bone length for the middle finger metacarpal bone).

The method 400 commences at opening loop operation 402 and proceeds to operation 404, where the XR device 110 detects that a new scale estimate is to be generated. For example, the XR device 110 detects that a tracked object has assumed an orientation that differs from all previously detected orientations in the time buffer 240 by at least a predetermined threshold value.

At operation 406, the XR device 110 launches the multi-camera mode for a calibration operation. For example, the multi-camera mode can be launched by the control system 226 of the XR device 110. The method 400 proceeds to operation 408, where the XR device 110 runs a tracker (e.g., using the object tracking component 220) to obtain 2D landmarks from a further camera view in addition to the camera view that was used to detect that the new scale estimate is to be generated. For instance, a first camera provides a main camera view that is processed to obtain (normalized) 3D landmarks for detecting the orientation of the object, while a second camera provides an additional or auxiliary camera view that is processed in the multi-camera mode.

The multi-camera mode the XR device 110 thus allows the XR device 110 to analyze features of the object as captured from two camera views (e.g., stereo image data). Stereo image data may include visual information captured simultaneously by two cameras of the XR device 110, providing multiple viewpoints of the object. For example, in a hand tracking context, the XR device 110 obtains (x, y) coordinates for predetermined landmarks of the hand from two different camera views (taken at the same point in time).

In some examples, the XR device 110 continuously captures images with both cameras (even in the single-camera mode), but only processes the images of one camera in the single-camera mode, while the images from both cameras are processed when the XR device 110 operates in the multi-camera mode.

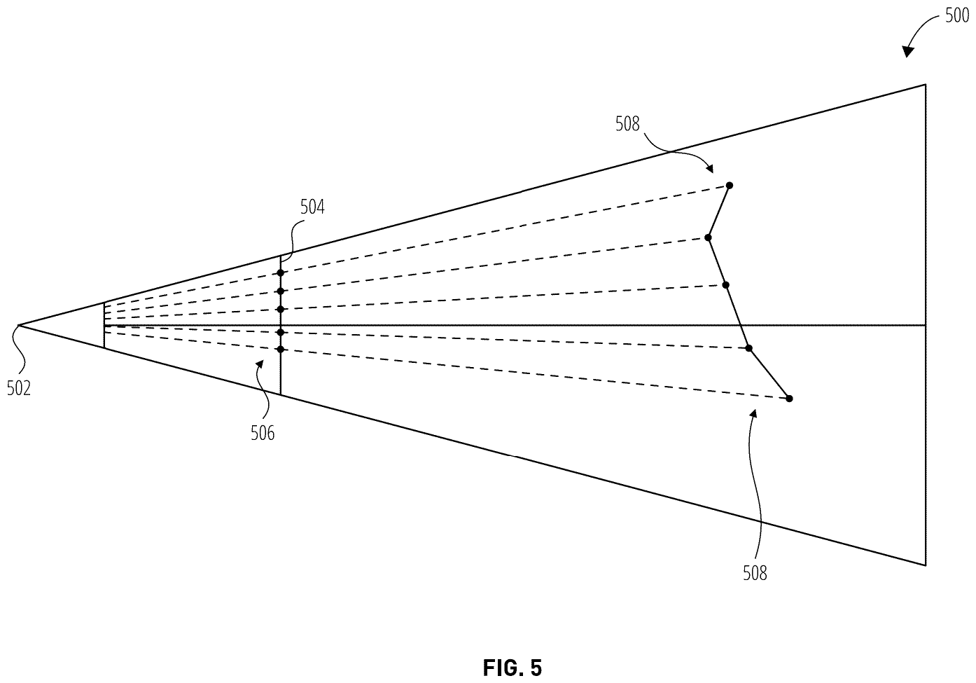

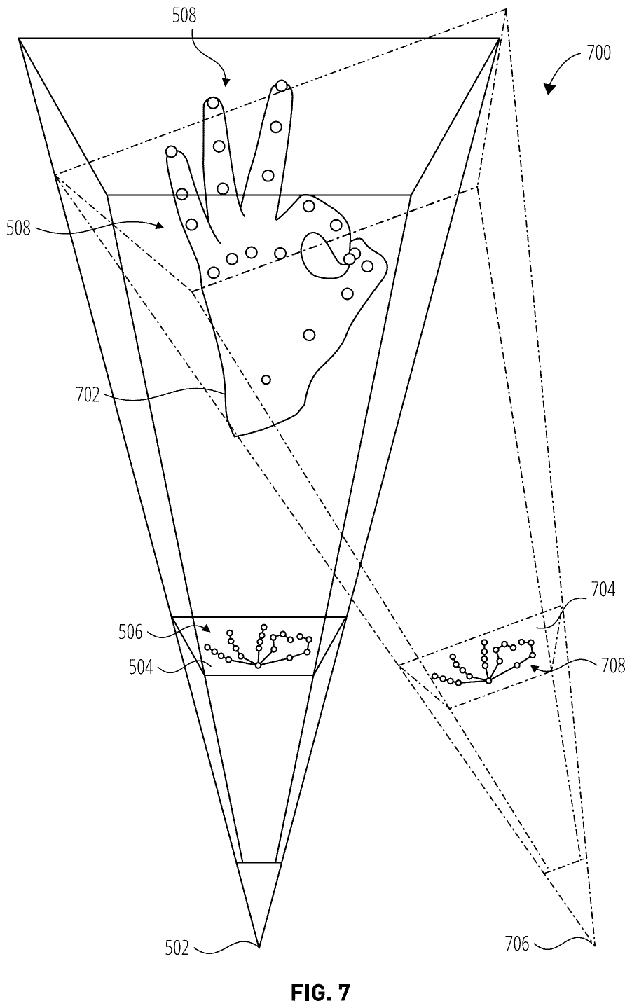

At operation 410, the XR device 110 of the XR device 110 processes the stereo image data (e.g., including at least 2D landmark positions from both camera perspectives) and performs triangulation to estimate the true 3D coordinates of the relevant object landmarks. For example, the scale estimation component 224 estimates the (absolute) 3D coordinates as follows:
The scale estimation component 224 initially obtains 3D landmarks in normalized camera space. As discussed above, 2D landmarks from the main camera view (e.g., image plane of the first camera associated with the single-camera mode) may be “lifted” into 3D space by the object tracking component 220. An example of this operation is illustrated in, and further discussed with reference to, FIG. 5.
The 2D locations of the landmarks in the additional camera view (e.g., image plane of the second camera) are obtained.
Correspondences between the 2D locations of the landmarks in the additional camera view and the 3D landmarks in the normalized space are found.
A true location of each 3D landmark is estimated by minimizing the reprojection distance of the 3D landmarks onto the two different camera views. In this context, the reprojection distance refers to the difference between where a 3D point projects onto each camera's image plane and where the actual 2D landmark was detected by the XR device 110. An example of this operation is illustrated in, and further discussed with reference to, FIG. 7.

The aforementioned triangulation technique is a non-limiting example, and other techniques may be used. Generally, it is noted that triangulation is possible when the relevant parameters of the cameras are known (e.g., from factory calibration). The stereo image data can include synchronized images from two cameras with known relative positions and orientations, as well as other relevant parameters. The relevant parameters are often referred to as the “intrinsics” and “extrinsics.” In this context, camera extrinsic parameters can include, for example, relative transformations between the cameras, and camera intrinsic parameters can include, for example, focal length or principal point. Lens distortion parameters may also be known and applied in this regard.

After the true locations of each 3D landmark have been estimated, the method 400 proceeds to operation 412, where the scale estimation component 224 of the XR device 110 measures a distance between two of the 3D landmarks to obtain the new scale estimate for the tracked object. For example, in a hand tracking context, the scale estimation component 224 measures the absolute distance between the wrist landmark and the index finger metacarpal landmark of the tracked hand. This distance is then set by the XR device 110 as the new scale estimate so as to represent the overall object scale.

At operation 414, the new scale estimate is associated with the corresponding orientation of the object, and the new scale estimate is added to the time buffer 240 for use during the user session. For example, the XR device 110 adds a new entry in the time buffer 240 that consists of the new scale estimate (e.g., a distance or length value) and its corresponding orientation (e.g., an angular value).

The new scale estimate is used by the XR device 110 for object tracking (e.g., as the currently selected scale estimate, as discussed with reference to FIG. 3) at operation 416. For example, in a hand tracking context, the ratio between the new scale estimate and the same measure on the normalized hand (e.g., in the 3D normalized space) are applied by the XR device 110 to proportionally re-scale the entire hand.

As mentioned, once the calibration operation is completed, the XR device 110 can automatically switch back to the single-camera mode. In the single-camera mode, the XR device 110 uses the newly generated scale estimate to obtain accurate 3D positional information for the object, such as to infer 3D landmarks with absolute depth information based on an initial set of positional data with relative depth information. In some examples, the XR device 110 uses a bone length estimate together with new 2D positional data of the object, obtained from a single camera view in subsequent image frames, to generate 3D positional data of the object for those frames.

Since the new scale estimate is added to the time buffer 240, the new scale estimate can be used for both immediate tracking of the object and as part of (e.g., weighted component of) an effective scale estimate that is generated by the XR device 110 later during the user session. In other words, the XR device 110 can track the object both directly and indirectly based on the newly generated scale estimate. The method 400 concludes at closing loop operation 418.

In some examples, the XR device 110 checks a reprojection error to determine whether a measurement is viable, and only uses a particular measurement if the reprojection error is sufficiently small (e.g., the error is within a predetermined margin of error). The checking of the reprojection error may include assessing the accuracy of the 3D reconstruction of the landmarks by projecting the calculated 3D points back onto the 2D image planes of the relevant cameras and comparing them to the original 2D points.

Furthermore, in some examples, the process of obtaining a measurement a scale estimate (e.g., measuring a bone length) can be repeated (e.g., across multiple frames) until the value stabilizes, or converges. A predetermined stabilization threshold can be used to determine whether the scale estimate has stabilized sufficiently.

FIG. 5 is diagram 500 that illustrates 2D landmarks 506 and 3D landmarks 508 of an object relative to a first camera of the XR device 110, referred to below as a main camera 502. The 3D landmarks 508 are generated using the 2D landmarks 506 from an image plane 504 associated with the main camera 502. In the example of FIG. 5, the object is a hand (e.g., a hand of the user 106).

In some examples, the XR device 110 runs a lifter network to “lift” the 2D landmarks 506 into 3D space, producing the 3D landmarks 508 in a normalized form. Depth (e.g., the distance between the image plane 504 and the actual positions of the 3D landmarks 508 along a camera axis) may be ambiguous from a single camera view.

The 3D landmarks 508 of FIG. 5 may correspond to landmarks (or a subset of the landmarks) on a kinematic model of a hand. FIG. 6 diagrammatically illustrates a kinematic model 600 of a hand, according to some examples. The kinematic model 600 represents the hand as a series of joints 602 that are interconnected by links, as shown in FIG. 6. For example, each of the joints 602 corresponds to a respective 3D landmark (e.g., one of the 3D landmarks 508).

The pose or orientation of a hand can be expressed, approximated, or represented in numerous ways. In some examples, and as shown in FIG. 6, the orientation of the hand is represented by a plane 604 that is fitted to a palm region of the hand.

For example, the plane 604 is generated by the XR device 110 by processing the relative positions of the following six landmarks (e.g., as obtained from a lifter network or another machine learning model that estimates relative 3D landmark positions): a wrist joint 606, a metacarpal joint 608 of the thumb, a metacarpal joint 610 of the index finger, a metacarpal joint 612 of the middle finger, a metacarpal joint 614 of the ring finger, and a metacarpal joint 616 of the pinky finger. The plane 604 can thus be generated by calculating a plane that best fits the aforementioned landmarks.

An orientation, such as the orientation of the plane 604, may represent the pose of the hand. This pose can be associated with a specific scale estimate, such as a new scale estimate that is generated according to the method 400 of FIG. 4. The XR device 110 may continuously track the orientation of the plane 604 over time (e.g., during a user session).

FIG. 7 is a diagram 700 that shows the image plane 504 of the main camera 502 and the 3D landmarks 508 of FIG. 5, as well as a further image plane 704 of an auxiliary camera 706 of the XR device 110, depicting 2D landmarks 708. As stated with reference to FIG. 5, the tracked object is a hand 702. The 2D landmarks 708 depict are the same landmarks as the 2D landmarks 506, but are captured from a different perspective.

FIG. 7 illustrates how a multi-camera mode can be utilized. Specifically, the respective 2D landmarks (2D landmarks 506 and 2D landmarks 708) from the image plane 504 and the image plane 704 are processed to generate a new scale estimate for the hand, as follows:
The 2D landmarks 708 in the additional camera view are obtained by processing image data from the auxiliary camera 706. In this example, the 2D landmarks 506 associated with the main camera 502 were previously obtained.
Correspondences between the 2D landmarks 708 and the 3D landmarks 508, that were previously “lifted” from the 2D landmarks 506 associated with the main camera 502, are determined.
A true location of each of the 3D landmarks 508 is estimated by minimizing the reprojection distance of the 3D landmarks 508 onto the two different camera views (image plane 504 and 2D landmarks 708). In other words, the XR device 110 automatically solves for a scale estimate (e.g., one or more bone lengths in the hand 702) that minimizes this reprojection distance.
The scale estimate can then be selected by checking the absolute 3D distance between the relevant landmarks.

FIG. 8 is a graph 800 illustrating an orientation trajectory 802 of a tracked object (e.g., a hand), from a starting point (t[0]) in a user session until a subsequent point in time (t[N]) in the user session, according to some examples.

In a hand tracking scenario, the orientation trajectory 802 shows, for example, how the orientation of the palm changes during the user session. The orientation trajectory 802 is shown in orientation space, with the small, spaced apart circular elements depicting samples that are 10 degrees apart. The small, spaced apart circular elements represent a grid of orientations serving as a reference for potential hand orientations, while the continuous line shows the actual orientation trajectory 802.

The square elements on the orientation trajectory 802 indicate the specific points where a new scale estimation was triggered. In the example of FIG. 8, a new scale estimation is only triggered when the orientation of the object, at a particular point in time, is more than 20 degrees away from any previously detected orientation, as indicated by the larger circular elements that are traversed by the orientation trajectory 802. Accordingly, in the example of FIG. 8, the threshold value for determining whether a current orientation of an object corresponds to any previously detected orientation (e.g., in the time buffer 240) is 20 degrees of angular difference.

For example, if, at a particular point during the user session, the angular difference between a current orientation of the object is more than 20 degrees away from all previously detected orientations for the user session (for which scale estimates have already been generated), a new scale estimate is generated by the computing device (e.g., the XR device 110). On the other hand, if the angular difference between the current orientation and at least one of the previously detected orientations (for which a scale estimate has already been generated) is 20 degrees or less, the computing device generates an effective scale estimate based on a combination of the known scale estimates for the previously detected orientations instead of triggering the generation of a completely new scale estimate.

It is noted that the threshold value of 20 degrees is merely an example. A threshold value may be based on various factors, such as tradeoffs between accuracy and power consumption. For example, when a lower threshold is selected (e.g., an orientation has to be relatively close to at least one previous orientation to trigger the generation of an effective scale estimate), this can result in the computing device running more calibrations to obtain new scale estimates, which can increase accuracy, but cause higher power consumption due to increased usage of the multi-camera mode. On the other hand, if a higher threshold is selected (e.g., an orientation can trigger an effective scale estimate even if it is relatively far from previous orientations), this can allow the computing device to run fewer calibrations, resulting in longer periods of single-camera tracking or processing, and in turn lower power consumption (but the computing device then has to rely, to a greater extent, on existing scale estimates).

FIG. 9 is a graph 900 illustrating angular distances between a current orientation of an object, at time n (t[n]) and various previously detected orientations of the object. Each of the previously detected orientations has an associated scale estimate that was generated by the computing device (e.g., the XR device 110) by way of a calibration operation. Values of the associated scale estimates are also shown in FIG. 9. The scale estimates may be distance or length values.

The previously detected orientations and/or their associated scale estimates are temporarily stored, for instance, in the time buffer 240 of FIG. 2. In some examples, the time buffer 240 stores only one of the detected orientations and its associated scale estimate, with the other item in the pair being stored elsewhere. For example, the time buffer 240 stores the detected orientation with a pointer or identifier that enables the associated scale estimate to be retrieved, or the time buffer 240 stores the scale estimate with a point or identifier that enables the associated detected orientation to be retrieved.

It is noted that the respective scale estimates associated with the previously detected orientations appear out of order with respect to time in FIG. 9. Instead, the respective scale estimates associated with the previously detected orientation are ordered and spaced by angular distance from the current orientation. In some examples, based on this ordering and spacing, the respective scale estimates associated with the previously detected orientations are differentially weighted using a weighting function, such as a monotonically decreasing weighting function, to generate an effective scale estimate associated with the current orientation.

The computing device thus uses a weighting function to determine a weight of each respective scale estimate within the effective scale estimate. A curve 902 is included in FIG. 9 to illustrate the relative weighting of each scale estimate, according to some examples. The curve 902 illustrates exponential fall-off (e.g., exponential decay) as a function of angular distance as a non-limiting example of a monotonically decreasing weighting function.

FIG. 9 thus illustrates the manner in which an effective scale estimate may be generated based on a combination of existing scale estimates associated with previously detected orientations. Each of the scale estimates contribute to the effective scale estimate for time n based on the angular difference between the current orientation and that particular scale estimate's associated orientation.

For example, and as shown in FIG. 9, a first example scale estimate generated by the computing device for time n-4 contributes proportionally more to the effective scale estimate for time n than a second example scale estimate generated by the computing device for time n-1, because the orientation associated with the first example scale estimate is closer to the current orientation than the orientation associated with the second example scale estimate is to the current orientation. In other words, the first example scale estimate contributes more than the second example scale estimate to the effective scale estimate generated by the computing device even though it was generated earlier in time than the second example scale estimate.

As mentioned, previously detected orientations together with their corresponding scale estimates can be stored in a time buffer (e.g., the time buffer 240) that is dynamically updated over time. For example, the time buffer has a predetermined time window of three minutes, and only measurements or samples that were captured during the immediately preceding three-minute time window are considered by the computing device with respect to time n when determining whether to generate an effective scale estimate (and in performing the actual generation of the effective scale estimate, where relevant).

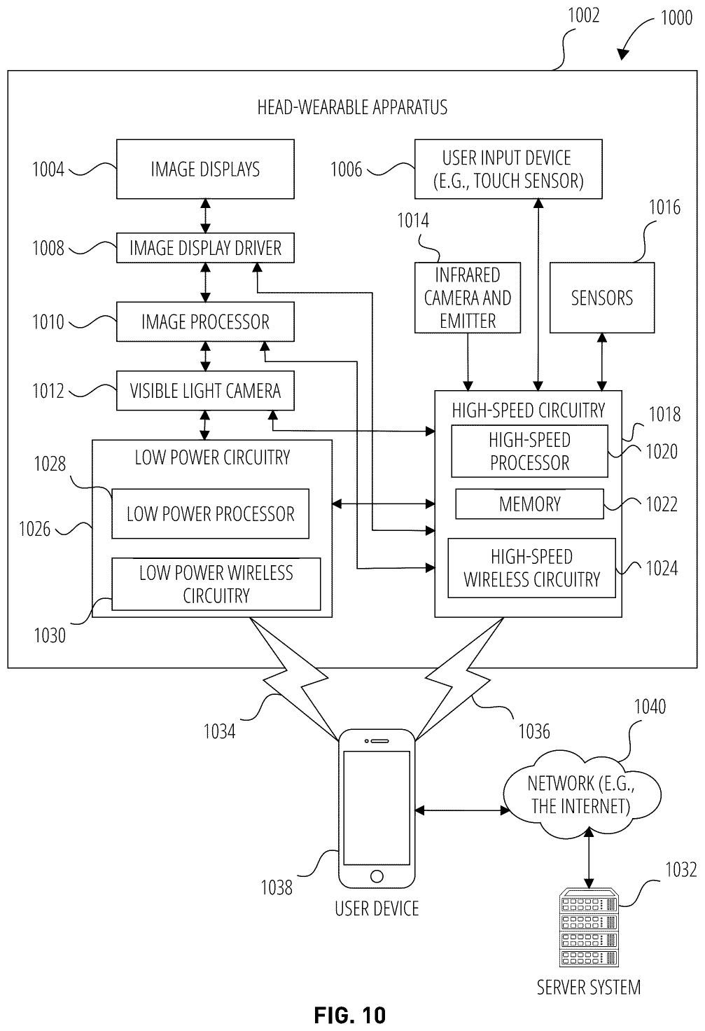

FIG. 10 illustrates a network environment 1000 in which a head-wearable apparatus 1002, such as a head-wearable XR device, can be implemented according to some examples. FIG. 10 provides a high-level functional block diagram of an example head-wearable apparatus 1002 communicatively coupled to a mobile user device 1038 and a server system 1032 via a suitable network 1040. One or more of the techniques described herein may be performed using the head-wearable apparatus 1002 or a network of devices similar to those shown in FIG. 10.

The head-wearable apparatus 1002 includes a camera, such as at least one of a visible light camera 1012 and an infrared camera and emitter 1014 (or multiple cameras). The head-wearable apparatus 1002 includes other sensors 1016, such as motion sensors or eye tracking sensors. The user device 1038 can be capable of connecting with head-wearable apparatus 1002 using both a communication link 1034 and a communication link 1036. The user device 1038 is connected to the server system 1032 via the network 1040. The network 1040 may include any combination of wired and wireless connections.

The head-wearable apparatus 1002 includes a display arrangement that has several components. For example, the arrangement includes two image displays 1004 of an optical assembly. The two displays include one associated with the left lateral side and one associated with the right lateral side of the head-wearable apparatus 1002. The head-wearable apparatus 1002 also includes an image display driver 1008, an image processor 1010, low power circuitry 1026, and high-speed circuitry 1018. The image displays 1004 are for presenting images and videos, including an image that can provide a graphical user interface to a user of the head-wearable apparatus 1002.

The image display driver 1008 commands and controls the image display of each of the image displays 1004. The image display driver 1008 may deliver image data directly to each image display of the image displays 1004 for presentation or may have to convert the image data into a signal or data format suitable for delivery to each image display device. For example, the image data may be video data formatted according to compression formats, such as H. 264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (Exif) or the like.

The head-wearable apparatus 1002 may include a frame and stems (or temples) extending from a lateral side of the frame, or another component to facilitate wearing of the head-wearable apparatus 1002 by a user. The head-wearable apparatus 1002 of FIG. 10 further includes a user input device 1006 (e.g., touch sensor or push button) including an input surface on the head-wearable apparatus 1002. The user input device 1006 is configured to receive, from the user, an input selection to manipulate the graphical user interface of the presented image.

The components shown in FIG. 10 for the head-wearable apparatus 1002 are located on one or more circuit boards, for example a printed circuit board (PCB) or flexible PCB, in the rims or temples. Alternatively, or additionally, the depicted components can be located in the chunks, frames, hinges, or bridges of the head-wearable apparatus 1002. Left and right sides of the head-wearable apparatus 1002 can each include a digital camera element such as a complementary metal-oxide-semiconductor (CMOS) image sensor, charge coupled device, a camera lens, or any other respective visible or light capturing elements that may be used to capture data, including images of scenes with unknown objects.

The head-wearable apparatus 1002 includes a memory 1022 which stores instructions to perform a subset or all of the functions described herein. The memory 1022 can also include a storage device. As further shown in FIG. 10, the high-speed circuitry 1018 includes a high-speed processor 1020, the memory 1022, and high-speed wireless circuitry 1024. In FIG. 10, the image display driver 1008 is coupled to the high-speed circuitry 1018 and operated by the high-speed processor 1020 in order to drive the left and right image displays of the image displays 1004. The high-speed processor 1020 may be any processor capable of managing high-speed communications and operation of any general computing system needed for the head-wearable apparatus 1002. The high-speed processor 1020 includes processing resources needed for managing high-speed data transfers over the communication link 1036 to a wireless local area network (WLAN) using high-speed wireless circuitry 1024. In certain examples, the high-speed processor 1020 executes an operating system such as a LINUX operating system or other such operating system of the head-wearable apparatus 1002 and the operating system is stored in memory 1022 for execution. In addition to any other responsibilities, the high-speed processor 1020 executing a software architecture for the head-wearable apparatus 1002 is used to manage data transfers with high-speed wireless circuitry 1024. In certain examples, high-speed wireless circuitry 1024 is configured to implement Institute of Electrical and Electronic Engineers (IEEE) 1002.11 communication standards, also referred to herein as Wi-Fi™. In other examples, other high-speed communications standards may be implemented by high-speed wireless circuitry 1024.

The low power wireless circuitry 1030 and the high-speed wireless circuitry 1024 of the head-wearable apparatus 1002 can include short range transceivers (Bluetooth™) and wireless wide, local, or wide area network transceivers (e.g., cellular or Wi-Fi™). The user device 1038, including the transceivers communicating via the communication link 1034 and communication link 1036, may be implemented using details of the architecture of the head-wearable apparatus 1002, as can other elements of the network 1040.

The memory 1022 includes any storage device capable of storing various data and applications, including, among other things, camera data generated by the visible light camera 1012, sensors 1016, and the image processor 1010, as well as images generated for display by the image display driver 1008 on the image displays 1004. While the memory 1022 is shown as integrated with the high-speed circuitry 1018, in other examples, the memory 1022 may be an independent standalone element of the head-wearable apparatus 1002. In certain such examples, electrical routing lines may provide a connection through a chip that includes the high-speed processor 1020 from the image processor 1010 or low power processor 1028 to the memory 1022. In other examples, the high-speed processor 1020 may manage addressing of memory 1022 such that the low power processor 1028 will boot the high-speed processor 1020 any time that a read or write operation involving memory 1022 is needed.

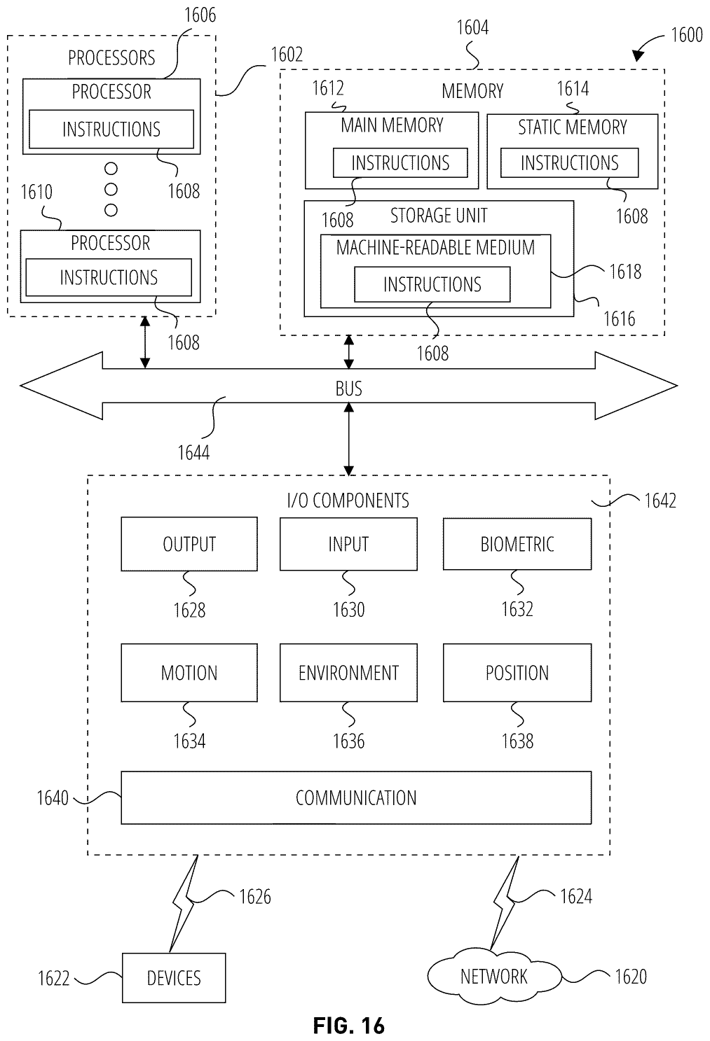

As shown in FIG. 10, the low power processor 1028 or high-speed processor 1020 of the head-wearable apparatus 1002 can be coupled to the camera (e.g., visible light camera 1012, or infrared camera and emitter 1014), the image display driver 1008, the user input device 1006 (e.g., touch sensor or push button), and the memory 1022. The head-wearable apparatus 1002 also includes sensors 1016, which may be the motion components 1634, position components 1638, environmental components 1636, or biometric components 1632, e.g., as described below with reference to FIG. 16. In particular, motion components 1634 and position components 1638 are used by the head-wearable apparatus 1002 to determine and keep track of the position and orientation of the head-wearable apparatus 1002 relative to a frame of reference or another object, in conjunction with a video feed from one of the visible light cameras 1012, using for example techniques such as structure from motion (SfM) or VIO.

In some examples, and as shown in FIG. 10, the head-wearable apparatus 1002 is connected with a host computer. For example, the head-wearable apparatus 1002 is paired with the user device 1038 via the communication link 1036 or connected to the server system 1032 via the network 1040. The server system 1032 may be one or more computing devices as part of a service or network computing system, for example, that include a processor, a memory, and network communication interface to communicate over the network 1040 with the user device 1038 and head-wearable apparatus 1002.

The user device 1038 includes a processor and a network communication interface coupled to the processor. The network communication interface allows for communication over the network 1040, communication link 1034 or communication link 1036. The user device 1038 can further store at least portions of the instructions for implementing functionality described herein.

Output components of the head-wearable apparatus 1002 include visual components, such as a display (e.g., one or more liquid-crystal display (LCD)), one or more plasma display panel (PDP), one or more light emitting diode (LED) display, one or more projector, or one or more waveguide. The image displays 1004 of the optical assembly are driven by the image display driver 1008. The output components of the head-wearable apparatus 1002 may further include acoustic components (e.g., speakers), haptic components (e.g., a vibratory motor), other signal generators, and so forth. The input components of the head-wearable apparatus 1002, the user device 1038, and server system 1032, such as the user input device 1006, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 1002 may optionally include additional peripheral device elements. Such peripheral device elements may include biometric sensors, additional sensors, or display elements integrated with the head-wearable apparatus 1002. For example, peripheral device elements may include any input/output (I/O) components including output components, motion components, position components, or any other such elements described herein.

For example, the biometric components include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi™ or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over a communication link 1036 from the user device 1038 via the low power wireless circuitry 1030 or high-speed wireless circuitry 1024.

Any biometric data collected by biometric components is captured and stored only after explicit user approval and deleted on user request. Further, such biometric data is used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

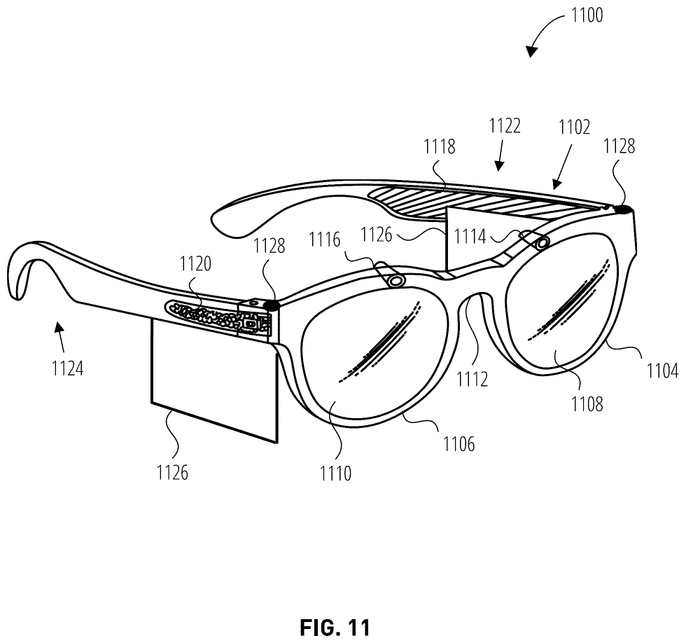

FIG. 11 is a perspective view of a head-worn XR device in the form of glasses 1100, according to some examples. The glasses 1100 can include a frame 1102 made from any suitable material such as plastic or metal, including any suitable shape memory alloy. In one or more examples, the frame 1102 includes a first or left optical element holder 1104 (e.g., a display or lens holder) and a second or right optical element holder 1106 connected by a bridge 1112. A first or left optical element 1108 and a second or right optical element 1110 can be provided within respective left optical element holder 1104 and right optical element holder 1106. The right optical element 1110 and the left optical element 1108 can be a lens, a display, a display assembly, or a combination of the foregoing. Any suitable display assembly can be provided in the glasses 1100.

The frame 1102 additionally includes a left arm or temple piece 1122 and a right arm or temple piece 1124. In some examples the frame 1102 can be formed from a single piece of material so as to have a unitary or integral construction.

The glasses 1100 can include a computing device, such as a computer 1120, which can be of any suitable type so as to be carried by the frame 1102 and, in one or more examples, of a suitable size and shape, so as to be partially disposed in one of the temple piece 1122 or the temple piece 1124. The computer 1120 can include one or more processors with memory, wireless communication circuitry, and a power source. The computer 1120 may comprise low-power circuitry, high-speed circuitry, and a display processor. Various other examples may include these elements in different configurations or integrated together in different ways.

The computer 1120 additionally includes a battery 1118 or other suitable portable power supply. In some examples, the battery 1118 is disposed in left temple piece 1122 and is electrically coupled to the computer 1120 disposed in the right temple piece 1124. The glasses 1100 can include a connector or port (not shown) suitable for charging the battery 1118, a wireless receiver, transmitter or transceiver (not shown), or a combination of such devices.

The glasses 1100 include a first or left camera 1114 and a second or right camera 1116. Although two cameras are depicted, other examples contemplate the use of a single or additional (i.e., more than two) cameras. In one or more examples, the glasses 1100 include any number of input sensors or other input/output devices in addition to the left camera 1114 and the right camera 1116. Such sensors or input/output devices can additionally include biometric sensors, location sensors, motion sensors, and so forth.

In some examples, the left camera 1114 and the right camera 1116 provide video frame data for use by the glasses 1100 to extract 3D information (for example) from a real world scene. The glasses 1100 may also include a touchpad 1126 mounted to or integrated with one or both of the left temple piece 1122 and right temple piece 1124. The touchpad 1126 is generally vertically-arranged, approximately parallel to a user's temple in some examples. As used herein, generally vertically aligned means that the touchpad is more vertical than horizontal, although potentially more vertical than that. Additional user input may be provided by one or more buttons 1128, which in the illustrated examples are provided on the outer upper edges of the left optical element holder 1104 and right optical element holder 1106. The one or more touchpads 1126 and buttons 1128 provide a means whereby the glasses 1100 can receive input from a user of the glasses 1100.

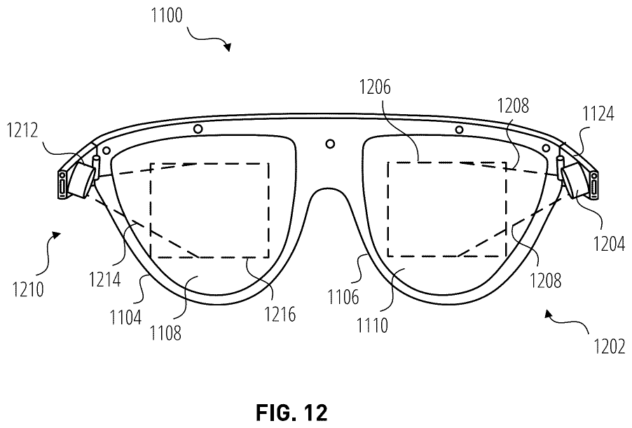

FIG. 12 illustrates the glasses 1100 from the perspective of a user. For clarity, a number of the elements shown in FIG. 11 have been omitted. As described with reference to FIG. 11, the glasses 1100 shown in FIG. 12 include left optical element 1108 and right optical element 1110 secured within the left optical element holder 1104 and the right optical element holder 1106 respectively.

The glasses 1100 include forward optical assembly 1202 comprising a right projector 1204 and a right near eye display 1206, and a forward optical assembly 1210 including a left projector 1212 and a left near eye display 1216.

In some examples, the near eye displays are waveguides. The waveguides include reflective or diffractive structures (e.g., gratings and/or optical elements such as mirrors, lenses, or prisms). Light 1208 emitted by the projector 1204 encounters the diffractive structures of the waveguide of the near eye display 1206, which directs the light towards the right eye of a user to provide an image on or in the right optical element 1110 that overlays the view of the real world seen by the user. Similarly, light 1214 emitted by the projector 1212 encounters the diffractive structures of the waveguide of the near eye display 1216, which directs the light towards the left eye of a user to provide an image on or in the left optical element 1108 that overlays the view of the real world seen by the user.

In some examples, the combination of a graphics processing unit (GPU), the forward optical assembly 1202, the left optical element 1108, and the right optical element 1110 provide an optical engine of the glasses 1100. The glasses 1100 use the optical engine to generate an overlay of the real world view of the user including display of a 3D user interface to the user of the glasses 1100.

It will be appreciated however that other display technologies or configurations may be utilized within an optical engine to display an image to a user in the user's field of view. For example, instead of a projector 1204 and a waveguide, an LCD, LED or other display panel or surface may be provided.

In use, a user of the glasses 1100 will be presented with information, content, and various 3D user interfaces on the near eye displays. As described in more detail herein, the user can then interact with the glasses 1100 using a touchpad 1126 and/or the buttons 1128, voice inputs or touch inputs on an associated device, and/or hand movements, locations, and positions detected by the glasses 1100.

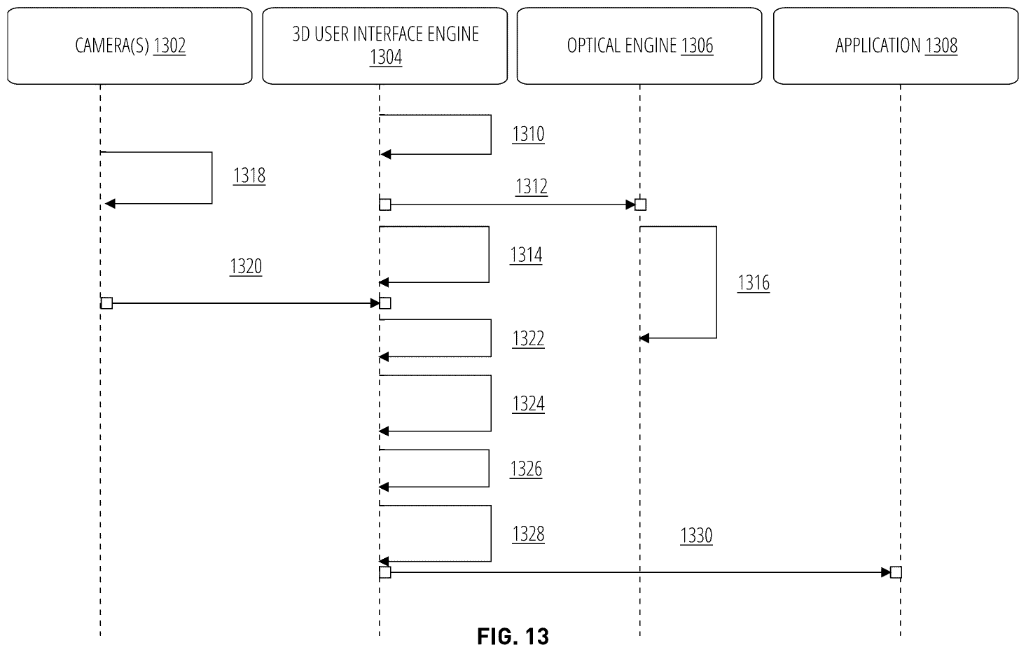

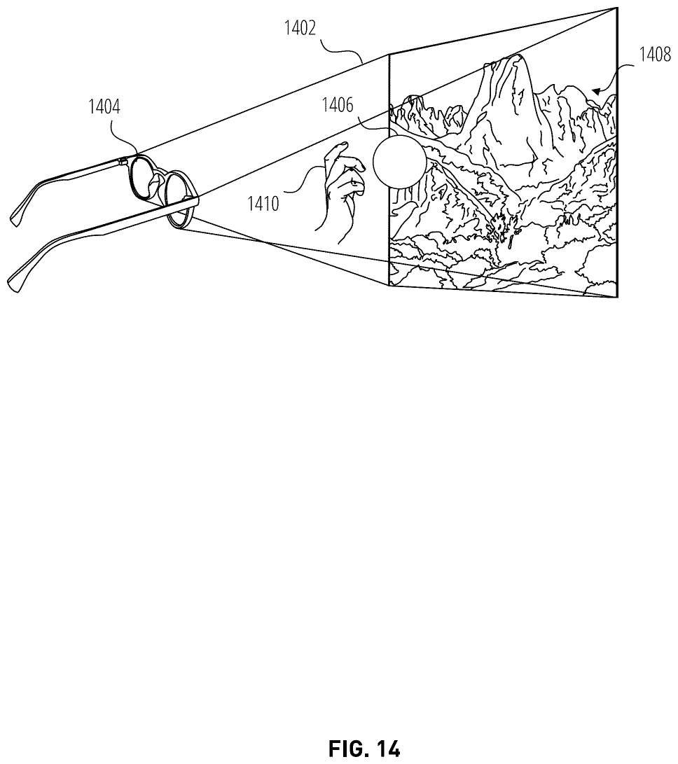

Referring now to FIG. 13 and FIG. 14, FIG. 13 depicts a sequence diagram of an example 3D user interface process and FIG. 14 depicts a 3D user interface 1402 of glasses 1404 in accordance with some examples. During the process, a 3D user interface engine 1304 generates 1310 the 3D user interface 1402 including one or more virtual objects 1406 that constitute interactive elements of the 3D user interface 1402.

A virtual object may be described as a solid in a 3D geometry having values in 3-tuples of X (horizontal), Y (vertical), and Z (depth). A 3D render of the 3D user interface 1402 is generated and 3D render data 1312 is communicated to an optical engine 1306 of the glasses 1404 and displayed 1316 to a user of the glasses 1404. The 3D user interface engine 1304 generates 1314 one or more virtual object colliders for the one or more virtual objects. One or more camera(s) 1302 of the glasses 1404 generate 1318 real world video frame data 1320 of the real world 1408 as viewed by the user of the glasses 1404.

Included in the real world video frame data 1320 is hand position video frame data of one or more of the user's hands 1410 from a viewpoint of the user while wearing the glasses 1404 and viewing the projection of the 3D render of the 3D user interface 1402 by the optical engine 1306. Thus the real world video frame data 1320 include hand location video frame data and hand position video frame data of the user's hands 1410 as the user makes movements with their hands.

The 3D user interface engine 1304 or other components of the glasses 1404 utilize the hand location video frame data and hand position video frame data in the real world video frame data 1320 to extract landmarks 1322 of the user's hands 1410 from the real world video frame data 1320 and generates 1324 landmark colliders for one or more landmarks on one or more of the user's hands 1410.

The landmark colliders are used to determine user interactions between the user and the virtual object by detecting collisions 1326 between the landmark colliders and respective visual object colliders of the virtual objects. The collisions are used by the 3D user interface engine 1304 to determine user interactions 1328 by the user with the virtual objects. The 3D user interface engine 1304 communicates user interaction data 1330 of the user interactions to an application 1308 for utilization by the application 1308.

In some examples, the application 1308 performs the functions of the 3D user interface engine 1304 by utilizing various APIs and system libraries to receive and process the real world video frame data 1320 and instruct the optical engine 1306.

In some examples, a user wears one or more sensor gloves or other sensors on the user's hands that generate sensed hand position data and sensed hand location data that is used to generate the landmark colliders. The sensed hand position data and sensed hand location data are communicated to the 3D user interface engine 1304 and used by the 3D user interface engine 1304 in lieu of or in combination with the hand location video frame data and hand position video frame data to generate landmark colliders for one or more landmarks on one or more of the user's hands 1410.

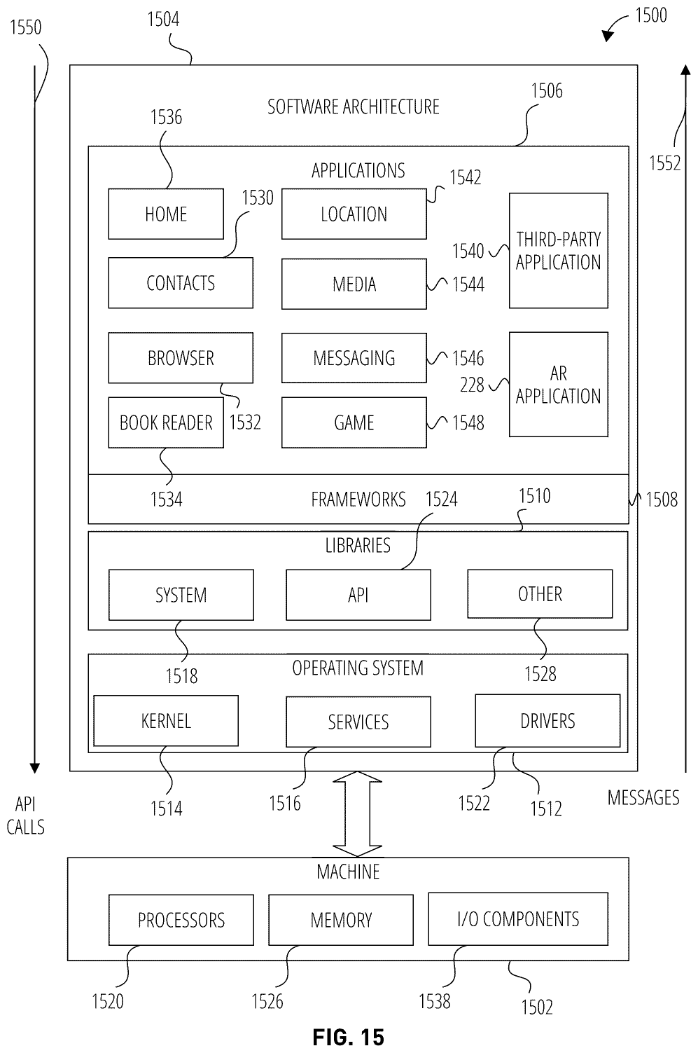

FIG. 15 is a block diagram 1500 illustrating a software architecture 1504, which can be installed on one or more of the devices described herein. The software architecture 1504 is supported by hardware such as a machine 1502 that includes processors 1520, memory 1526, and I/O components 1538. In this example, the software architecture 1504 can be conceptualized as a stack of layers, where each layer provides a particular functionality. The software architecture 1504 includes layers such as an operating system 1512, libraries 1510, frameworks 1508, and applications 1506. Operationally, the applications 1506 invoke API calls 1550, through the software stack and receive messages 1552 in response to the API calls 1550.

The operating system 1512 manages hardware resources and provides common services. The operating system 1512 includes, for example, a kernel 1514, services 1516, and drivers 1522. The kernel 1514 acts as an abstraction layer between the hardware and the other software layers. For example, the kernel 1514 provides memory management, processor management (e.g., scheduling), component management, networking, and security settings, among other functionality. The services 1516 can provide other common services for the other software layers. The drivers 1522 are responsible for controlling or interfacing with the underlying hardware. For instance, the drivers 1522 can include display drivers, camera drivers, Bluetooth™ or Bluetooth™ Low Energy drivers, flash memory drivers, serial communication drivers (e.g., Universal Serial Bus (USB) drivers), WI-FI™ drivers, audio drivers, power management drivers, and so forth.

The libraries 1510 provide a low-level common infrastructure used by the applications 1506. The libraries 1510 can include system libraries 1518 (e.g., C standard library) that provide functions such as memory allocation functions, string manipulation functions, mathematic functions, and the like. In addition, the libraries 1510 can include API libraries 1524 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in 2D and 3D in a graphic content on a display), database libraries (e.g., SQLite to provide various relational database functions), web libraries (e.g., WebKit to provide web browsing functionality), and the like. The libraries 1510 can also include a wide variety of other libraries 1528 to provide many other APIs to the applications 1506.

The frameworks 1508 provide a high-level common infrastructure that is used by the applications 1506. For example, the frameworks 1508 provide various graphical user interface (GUI) functions, high-level resource management, and high-level location services. The frameworks 1508 can provide a broad spectrum of other APIs that can be used by the applications 1506, some of which may be specific to a particular operating system or platform.

In some examples, the applications 1506 may include a home application 1536, a contacts application 1530, a browser application 1532, a book reader application 1534, a location application 1542, a media application 1544, a messaging application 1546, a game application 1548, and a broad assortment of other applications such as a third-party application 1540. The applications 1506 are programs that execute functions defined in the programs. Various programming languages can be employed to create one or more of the applications 1506, structured in a variety of manners, such as object-oriented programming languages (e.g., Objective-C, Java, or C++) or procedural programming languages (e.g., C or assembly language). In some examples, the third-party application 1540 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In FIG. 15, the third-party application 1540 can invoke the API calls 1550 provided by the operating system 1512 to facilitate functionality described herein. The applications 1506 may include an AR application such as the AR application 228 described herein, according to some examples.

FIG. 16 is a diagrammatic representation of a machine 1600 within which instructions 1608 (e.g., software, a program, an application, an applet, or other executable code) for causing the machine 1600 to perform one or more of the methodologies discussed herein may be executed. For example, the instructions 1608 may cause the machine 1600 to execute any one or more of the methods described herein.

The instructions 1608 transform the general, non-programmed machine 1600 into a particular machine 1600 programmed to carry out the described and illustrated functions in the manner described. The machine 1600 may operate as a standalone device or may be coupled (e.g., networked) to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), XR device, a smart home device (e.g., a smart appliance), other smart devices, a web appliance, a network router, a network switch, a network bridge, or any machine capable of executing the instructions 1608, sequentially or otherwise, that specify actions to be taken by the machine 1600. Further, while only a single machine 1600 is illustrated, the term “machine” shall also be taken to include a collection of machines that individually or jointly execute the instructions 1608 to perform any one or more of the methodologies discussed herein.

The machine 1600 may include processors 1602, memory 1604, and I/O components 1642, which may be configured to communicate with each other via a bus 1644. In some examples, the processors 1602 may include, for example, a processor 1606 and a processor 1610 that execute the instructions 1608. Although FIG. 16 shows multiple processors 1602, the machine 1600 may include a single processor with a single core, a single processor with multiple cores (e.g., a multi-core processor), multiple processors with a single core, multiple processors with multiples cores, or any combination thereof.

The memory 1604 includes a main memory 1612, a static memory 1614, and a storage unit 1616, accessible to the processors via the bus 1644. The main memory 1604, the static memory 1614, and storage unit 1616 store the instructions 1608 embodying any one or more of the methodologies or functions described herein. The instructions 1608 may also reside, completely or partially, within the main memory 1612, within the static memory 1614, within machine-readable medium 1618 within the storage unit 1616, within at least one of the processors, or any suitable combination thereof, during execution thereof by the machine 1600.

The I/O components 1642 may include a wide variety of components to receive input, provide output, produce output, transmit information, exchange information, capture measurements, and so on. The specific I/O components 1642 that are included in a particular machine will depend on the type of machine. For example, portable machines such as mobile phones may include a touch input device or other such input mechanisms, while a headless server machine will likely not include such a touch input device. It will be appreciated that the I/O components 1642 may include many other components that are not shown in FIG. 16. In various examples, the I/O components 1642 may include output components 1628 and input components 1630.

The output components 1628 may include visual components (e.g., a display such as a PDP, an LED display, a LCD, a projector, or a cathode ray tube (CRT)), acoustic components (e.g., speakers), haptic components (e.g., a vibratory motor, resistance mechanisms), other signal generators, and so forth. The input components 1630 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In some examples, the I/O components 1642 may include biometric components 1632, motion components 1634, environmental components 1636, or position components 1638, among a wide array of other components. For example, the biometric components 1632 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1634 include acceleration sensor components (e.g., accelerometer), gravitation sensor components, rotation sensor components (e.g., gyroscope), and so forth. The environmental components 1636 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1638 include location sensor components (e.g., a GPS receiver components), altitude sensor components (e.g., altimeters or barometers that detect air pressure from which altitude may be derived), orientation sensor components (e.g., magnetometers), and the like.

As mentioned, any biometric data collected by biometric components is captured and stored only after explicit user approval and deleted on user request. Further, such biometric data is used for very limited purposes, such as identification verification. To ensure limited and authorized use of biometric information and other PII, access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

Communication may be implemented using a wide variety of technologies. The I/O components 1642 further include communication components 1640 operable to couple the machine 1600 to a network 1620 or devices 1622 via a coupling 1624 and a coupling 1626, respectively. For example, the communication components 1640 may include a network interface component or another suitable device to interface with the network 1620. In further examples, the communication components 1640 may include wired communication components, wireless communication components, cellular communication components, Near Field Communication (NFC) components, Bluetooth™ components, Wi-Fi™ components, and other communication components to provide communication via other modalities. The devices 1622 may be another machine or any of a wide variety of peripheral devices (e.g., a peripheral device coupled via a USB).

Moreover, the communication components 1640 may detect identifiers or include components operable to detect identifiers. For example, the communication components 1640 may include Radio Frequency Identification (RFID) tag reader components, NFC smart tag detection components, optical reader components (e.g., an image sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1640, such as location via Internet Protocol (IP) geolocation, location via Wi-Fi™ signal triangulation, location via detecting an NFC beacon signal that may indicate a particular location, and so forth.

The various memories (e.g., memory 1604, main memory 1612, static memory 1614, and/or memory of the processors 1602) and/or storage unit 1616 may store one or more sets of instructions and data structures (e.g., software) embodying or used by any one or more of the methodologies or functions described herein. These instructions (e.g., the instructions 1608), when executed by processors 1602, cause various operations to implement the disclosed examples.

The instructions 1608 may be transmitted or received over the network 1620, using a transmission medium, via a network interface device (e.g., a network interface component included in the communication components 1640) and using any one of a number of well-known transfer protocols (e.g., hypertext transfer protocol (HTTP)). Similarly, the instructions 1608 may be transmitted or received using a transmission medium via the coupling 1626 (e.g., a peer-to-peer coupling) to the devices 1622.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks.

The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine 1600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Conclusion

Although aspects have been described with reference to specific examples, it will be evident that various modifications and changes may be made to these examples without departing from the broader scope of the present disclosure. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

As used herein, the term “processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) Processor, a Complex Instruction Set Computing (CISC) Processor, a GPU, a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), an FPGA, a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, Very Long Instruction Word (VLIW), vector processing, or Single Instruction, Multiple Data (SIMD) that allow each core to run separate instruction streams concurrently. A processor may be emulated in software, running on a physical processor, as a virtual processor or virtual circuit. The virtual processor may behave like an independent processor but is implemented in software rather than hardware.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

The various features, steps, operations, and processes described herein may be used independently of one another, or may be combined in various ways. All possible combinations and subcombinations are intended to fall within the scope of this disclosure. In addition, certain method or process blocks or operations may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLES

In view of the above-described implementations of subject matter this application discloses the following list of examples, wherein one feature of an example in isolation, or more than one feature of an example taken in combination, and, optionally, in combination with one or more features of one or more further examples, are further examples also falling within the disclosure of this application.

Example 1 is a method for facilitating object tracking, the method performed by a computing device and comprising: capturing, via one or more cameras of the computing device, at least one image of an object; detecting a current orientation of the object based on the at least one image; determining that a difference between the current orientation and at least one of a plurality of previously detected orientations of the object is less than a threshold value, each previously detected orientation of the plurality of previously detected orientations being associated with a respective scale estimate; in response to determining that the difference is less than the threshold value, generating an effective scale estimate for the object based on a combination of the respective scale estimates associated with the plurality of previously detected orientations, each respective scale estimate contributing to the effective scale estimate according to a respective difference between the current orientation and the previously detected orientation associated with the respective scale estimate; and tracking a pose of the object based on the effective scale estimate.

In Example 2, the subject matter of Example 1 includes, processing the at least one image of the object to obtain 2D landmarks associated with the object; and processing the 2D landmarks to generate 3D landmarks associated with the object, wherein the current orientation of the object is detected based on the 3D landmarks.

In Example 3, the subject matter of Example 2 includes, wherein the 2D landmarks are first 2D landmarks, the 3D landmarks are first 3D landmarks, the current orientation is a first orientation detected for a first point in time, and the method further comprises: obtaining second 2D landmarks associated with the object; processing the second 2D landmarks to obtain second 3D landmarks associated with the object; detecting, for a second point in time and based on the second 3D landmarks, a second orientation of the object that differs from the first orientation; determining that a difference between the second orientation and each respective previously detected orientation of the plurality of previously detected orientations meets or exceeds the threshold value; in response to determining that the difference between the second orientation and each respective previously detected orientation of the plurality of previously detected orientations meets or exceeds the threshold value, triggering commencement of a calibration operation to obtain a new scale estimate without utilizing the respective scale estimates associated with the plurality of previously detected orientations; and further tracking the pose of the object based on the new scale estimate.

In Example 4, the subject matter of Example 3 includes, wherein the one or more cameras comprise a plurality of cameras, and the calibration operation is performed in a multi-camera mode.

In Example 5, the subject matter of Example 4 includes, wherein the tracking of the pose of the object based on the effective scale estimate is performed in a single-camera mode, the method further comprising: automatically switching from the single-camera mode to the multi-camera mode to perform the calibration operation; and automatically switching from the multi-camera mode back to the single-camera mode after the calibration operation to perform the further tracking of the pose of the object based on the new scale estimate in the single-camera mode.

In Example 6, the subject matter of Examples 4-5 includes, wherein the second 3D landmarks are normalized 3D landmarks, the second 2D landmarks are associated with a first camera perspective, and the calibration operation comprises obtaining the new scale estimate by: obtaining further 2D landmarks from another camera perspective; and minimizing a reprojection distance for estimated true locations of the second 3D landmarks in relation to the second 2D landmarks and the further 2D landmarks.

In Example 7, the subject matter of Example 6 includes, wherein the new scale estimate comprises a distance between at least two estimated true locations of two of the second 3D landmarks.

In Example 8, the subject matter of Examples 3-7 includes, wherein the plurality of previously detected orientations is temporarily stored in a time buffer that is dynamically updated over time, the method further comprising: associating the new scale estimate with the second orientation; and updating the time buffer to include the new scale estimate.

In Example 9, the subject matter of Examples 1-8 includes, wherein the effective scale estimate comprises a weighted average of the respective scale estimates associated with the plurality of previously detected orientations.

In Example 10, the subject matter of Example 9 includes, wherein a weight of each respective scale estimate within the weighted average is based on a respective angular difference between the current orientation and the previously detected orientation associated with the respective scale estimate.

In Example 11, the subject matter of Example 10 includes, wherein the generating of the effective scale estimate comprises determining the weight of each respective scale estimate based on a monotonically decreasing weighting function.

In Example 12, the subject matter of Examples 1-11 includes, wherein the plurality of previously detected orientations is temporarily stored in a time buffer that is dynamically updated over time.

In Example 13, the subject matter of Example 12 includes, wherein each of the plurality of previously detected orientations was detected within a predetermined time window associated with the time buffer prior to the detecting of the current orientation.

In Example 14, the subject matter of Examples 2-13 includes, wherein the detecting of the current orientation comprises: fitting a plane to at least a subset of the 3D landmarks; determining an orientation of the plane; and applying the orientation of the plane as the current orientation.

In Example 15, the subject matter of Examples 2-14 includes, wherein the 3D landmarks are normalized 3D landmarks, and the tracking of the pose of the object based on the effective scale estimate comprises applying the effective scale estimate to the normalized 3D landmarks to obtain the pose of the object.

In Example 16, the subject matter of Examples 2-15 includes, wherein the processing of the at least one image and the processing of the 3D landmarks comprise executing at least one machine learning model.

In Example 17, the subject matter of Examples 1-16 includes, wherein the object is a hand of a person, and the effective scale estimate comprises at least one bone length estimate associated with the hand.

In Example 18, the subject matter of Examples 1-17 includes, wherein the computing device comprises an XR device, the method further comprising: generating, by the XR device, virtual content; determining positioning of the virtual content relative to the object based on the tracking of the pose of the object; and causing presentation of the virtual content according to the determined positioning.

Example 19 is an XR device comprising: at least one processor; and at least one memory storing instructions that, when executed by the at least one processor, cause the XR device to perform operations comprising: capturing, via one or more cameras of the XR device, at least one image of an object; detecting a current orientation of the object based on the at least one image; determining that a difference between the current orientation and at least one of a plurality of previously detected orientations of the object is less than a threshold value, each previously detected orientation of the plurality of previously detected orientations being associated with a respective scale estimate; in response to determining that the difference is less than the threshold value, generating an effective scale estimate for the object based on a combination of the respective scale estimates associated with the plurality of previously detected orientations, each respective scale estimate contributing to the effective scale estimate according to a respective difference between the current orientation and the previously detected orientation associated with the respective scale estimate; and tracking a pose of the object based on the effective scale estimate.

Example 20 is one or more non-transitory computer-readable storage media, the one or more non-transitory computer-readable storage media including instructions that, when executed by at least one processor, cause the at least one processor to perform operations comprising: obtaining, via one or more cameras, at least one image of an object; detecting a current orientation of the object based on the at least one image; determining that a difference between the current orientation and at least one of a plurality of previously detected orientations of the object is less than a threshold value, each previously detected orientation of the plurality of previously detected orientations being associated with a respective scale estimate; in response to determining that the difference is less than the threshold value, generating an effective scale estimate for the object based on a combination of the respective scale estimates associated with the plurality of previously detected orientations, each respective scale estimate contributing to the effective scale estimate according to a respective difference between the current orientation and the previously detected orientation associated with the respective scale estimate; and tracking a pose of the object based on the effective scale estimate.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

What is claimed is:

1. A method for facilitating object tracking, the method performed by a computing device and comprising:
capturing, via one or more cameras of the computing device, at least one image of an object;
detecting a current orientation of the object based on the at least one image;
determining that a difference between the current orientation and at least one of a plurality of previously detected orientations of the object is less than a threshold value, each previously detected orientation of the plurality of previously detected orientations being associated with a respective scale estimate;
in response to determining that the difference is less than the threshold value, generating an effective scale estimate for the object based on a combination of the respective scale estimates associated with the plurality of previously detected orientations, each respective scale estimate contributing to the effective scale estimate according to a respective difference between the current orientation and the previously detected orientation associated with the respective scale estimate; and
tracking a pose of the object based on the effective scale estimate.

2. The method of claim 1, further comprising:
processing the at least one image of the object to obtain two-dimensional (2D) landmarks associated with the object; and
processing the 2D landmarks to generate three-dimensional (3D) landmarks associated with the object, wherein the current orientation of the object is detected based on the 3D landmarks.

3. The method of claim 2, wherein the 2D landmarks are first 2D landmarks, the 3D landmarks are first 3D landmarks, the current orientation is a first orientation detected for a first point in time, and the method further comprises:
obtaining second 2D landmarks associated with the object;
processing the second 2D landmarks to obtain second 3D landmarks associated with the object;
detecting, for a second point in time and based on the second 3D landmarks, a second orientation of the object that differs from the first orientation;
determining that a difference between the second orientation and each respective previously detected orientation of the plurality of previously detected orientations meets or exceeds the threshold value;
in response to determining that the difference between the second orientation and each respective previously detected orientation of the plurality of previously detected orientations meets or exceeds the threshold value, triggering commencement of a calibration operation to obtain a new scale estimate without utilizing the respective scale estimates associated with the plurality of previously detected orientations; and
further tracking the pose of the object based on the new scale estimate.

4. The method of claim 3, wherein the one or more cameras comprise a plurality of cameras, and the calibration operation is performed in a multi-camera mode.

5. The method of claim 4, wherein the tracking of the pose of the object based on the effective scale estimate is performed in a single-camera mode, the method further comprising:
automatically switching from the single-camera mode to the multi-camera mode to perform the calibration operation; and
automatically switching from the multi-camera mode back to the single-camera mode after the calibration operation to perform the further tracking of the pose of the object based on the new scale estimate in the single-camera mode.

6. The method of claim 4, wherein the second 3D landmarks are normalized 3D landmarks, the second 2D landmarks are associated with a first camera perspective, and the calibration operation comprises obtaining the new scale estimate by:
obtaining further 2D landmarks from another camera perspective; and
minimizing a reprojection distance for estimated true locations of the second 3D landmarks in relation to the second 2D landmarks and the further 2D landmarks.

7. The method of claim 6, wherein the new scale estimate comprises a distance between at least two estimated true locations of two of the second 3D landmarks.

8. The method of claim 3, wherein the plurality of previously detected orientations is temporarily stored in a time buffer that is dynamically updated over time, the method further comprising:
associating the new scale estimate with the second orientation; and
updating the time buffer to include the new scale estimate.

9. The method of claim 1, wherein the effective scale estimate comprises a weighted average of the respective scale estimates associated with the plurality of previously detected orientations.

10. The method of claim 9, wherein a weight of each respective scale estimate within the weighted average is based on a respective angular difference between the current orientation and the previously detected orientation associated with the respective scale estimate.

11. The method of claim 10, wherein the generating of the effective scale estimate comprises determining the weight of each respective scale estimate based on a monotonically decreasing weighting function.

12. The method of claim 1, wherein the plurality of previously detected orientations is temporarily stored in a time buffer that is dynamically updated over time.

13. The method of claim 12, wherein each of the plurality of previously detected orientations was detected within a predetermined time window associated with the time buffer prior to the detecting of the current orientation.

14. The method of claim 2, wherein the detecting of the current orientation comprises:
fitting a plane to at least a subset of the 3D landmarks;
determining an orientation of the plane; and
applying the orientation of the plane as the current orientation.

15. The method of claim 2, wherein the 3D landmarks are normalized 3D landmarks, and the tracking of the pose of the object based on the effective scale estimate comprises applying the effective scale estimate to the normalized 3D landmarks to obtain the pose of the object.

16. The method of claim 2, wherein the processing of the at least one image and the processing of the 3D landmarks comprise executing at least one machine learning model.

17. The method of claim 1, wherein the object is a hand of a person, and the effective scale estimate comprises at least one bone length estimate associated with the hand.

18. The method of claim 1, wherein the computing device comprises an extended reality (XR) device, the method further comprising:
generating, by the XR device, virtual content;
determining positioning of the virtual content relative to the object based on the tracking of the pose of the object; and
causing presentation of the virtual content according to the determined positioning.

19. An extended reality (XR) device comprising:
at least one processor; and
at least one memory storing instructions that, when executed by the at least one processor, cause the XR device to perform operations comprising:
capturing, via one or more cameras of the XR device, at least one image of an object;
detecting a current orientation of the object based on the at least one image;
determining that a difference between the current orientation and at least one of a plurality of previously detected orientations of the object is less than a threshold value, each previously detected orientation of the plurality of previously detected orientations being associated with a respective scale estimate;
in response to determining that the difference is less than the threshold value, generating an effective scale estimate for the object based on a combination of the respective scale estimates associated with the plurality of previously detected orientations, each respective scale estimate contributing to the effective scale estimate according to a respective difference between the current orientation and the previously detected orientation associated with the respective scale estimate; and
tracking a pose of the object based on the effective scale estimate.

20. One or more non-transitory computer-readable storage media, the one or more non-transitory computer-readable storage media including instructions that, when executed by at least one processor, cause the at least one processor to perform operations comprising:
obtaining, via one or more cameras, at least one image of an object;
detecting a current orientation of the object based on the at least one image;
determining that a difference between the current orientation and at least one of a plurality of previously detected orientations of the object is less than a threshold value, each previously detected orientation of the plurality of previously detected orientations being associated with a respective scale estimate;
in response to determining that the difference is less than the threshold value, generating an effective scale estimate for the object based on a combination of the respective scale estimates associated with the plurality of previously detected orientations, each respective scale estimate contributing to the effective scale estimate according to a respective difference between the current orientation and the previously detected orientation associated with the respective scale estimate; and
tracking a pose of the object based on the effective scale estimate.
